(19) United States
(12) Patent Application Publication
(10) Pub. No.: US 2026/0134150 A1
(43) Pub. Date: May 14, 2026

(54) Blockchain-Verified Data Tracking System With Permission-Based Access Controls

(71) Applicant: Zoom Communications, Inc., San Jose, CA (US)

(72) Inventors: Xu Hua Li, San Jose, CA (US); Zhoujun Zhang, Hangzhou (CN)

(21) Appl. No.: 18/947,928

(22) Filed: Nov. 14, 2024

(51) Int. Cl. G06F 21/62; H04L 9/00

(52) U.S. Cl. CPC G06F 21/6263; H04L 9/50

(57) ABSTRACT

Blockchain-verified data tracking enables secure and transparent management of personal information across distributed networks. By leveraging cryptographic techniques and distributed ledger technology, various implementations may facilitate controlled data sharing while maintaining privacy and regulatory compliance. Permission-based access controls allow for granular management of data transactions. Anonymization and encryption methods further protect sensitive information during transfer and storage.

### FIELD

This disclosure generally relates to a data tracking system, and, more specifically, to a data governance platform that uses blockchain-verified data tracking.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a contact center system.

FIG. 6 is a block diagram of an example of an artificial intelligence (AI) system for processing user requests associated with software services of a software platform.

FIG. 7 is a block diagram of an example of a data governance platform for implementing data privacy management.

FIG. 8A is a schematic block diagram of an example associated with blockchain-verified data tracking in a data governance platform.

FIG. 8B is a diagram showing a conceptualization of building the blockchain of FIG. 8A.

FIG. 9 is a block diagram of an example of a system for data tracking using blockchain ledgers.

FIG. 10 is a block diagram of an example of an audit trail exposed for a blockchain ledger which stores records associated with data tracking.

FIG. 11 is a block diagram of an example of a system with decentralized storage.

FIG. 12 is a block diagram of an example of a block of a blockchain.

FIG. 13 is a schematic block diagram showing an example associated with blockchain-verified data tracking.

FIG. 14 is a schematic block diagram showing another example associated with blockchain-verified data tracking.

FIG. 15 is a schematic block diagram showing another example associated with blockchain-verified data tracking.

FIG. 16 is a schematic block diagram showing another example associated with blockchain-verified data tracking.

FIG. 17 is a schematic block diagram showing another example associated with blockchain-verified data tracking.

FIG. 18 is a flow diagram showing an example of a technique for implementing blockchain-verified data tracking.

FIG. 19 is a flow diagram showing another example of a technique for implementing blockchain-verified data tracking.

FIG. 20 is a flow diagram showing another example of a technique for implementing blockchain-verified data tracking.

### DETAILED DESCRIPTION

Enterprise entities rely upon several modes of communication to support their operations, including video conferencing, telephone, email, messaging, productivity tools, contact centers, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like. Other solutions include contact center as a service (CCaaS) and/or productivity tools, among other examples.

A software platform, such as a UCaaS platform or a CCaaS platform, may provide artificial intelligence (AI) functionality for use with the software services thereof. Use of the AI functionality may enhance the user experience by automating processes, answering prompted questions with minimal or no disruption to an active communication session, or introducing capabilities previously unavailable to software service users. Such AI functionality may be implemented using one or more machine learning models, which may be trained to process specific types of input and produce specific types of output. For example, machine learning functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to an LLM to ask for a summary of the discussion that occurred during the video conference before the participant joined. The LLM may evaluate a real-time transcription of the video conference (e.g., produced using automated speech recognition or a like tool) to present output concisely summarizing that discussion.

Machine learning models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the rapidly evolving landscape of data-driven technologies, organizations face increasingly complex challenges in managing and safeguarding sensitive information. The proliferation of digital platforms, cloud services, and interconnected systems has led to an exponential growth in data generation and collection. This surge in data volume and variety has created a pressing need for robust data governance frameworks that can effectively track, classify, and protect data across diverse environments. However, traditional data management approaches often struggle to keep pace with the dynamic nature of modern data ecosystems, leading to potential vulnerabilities in data privacy and compliance.

As organizations increasingly leverage AI and machine learning technologies to enhance their products and services, the volume and variety of personal data being processed have grown exponentially. This surge in data utilization has raised concerns about privacy, security, and compliance with data protection regulations. AI models often require vast amounts of training data to achieve high performance, and this data frequently includes sensitive personal information. Without proper safeguards and tracking mechanisms, organizations may inadvertently misuse or expose this data, leading to potential legal and ethical issues.

One of the challenges in this domain is the lack of comprehensive visibility into data flows and locations within an organization's digital infrastructure. As data moves through various systems, applications, and storage locations, it becomes increasingly difficult to maintain an accurate and up-to-date understanding of where sensitive information resides and how it is being used. This challenge is further compounded by the complexity of modern software development pipelines, where data may be accessed, processed, and stored across multiple stages and environments. The inability to effectively track and manage data throughout its lifecycle can lead to inadvertent exposure of sensitive information, compliance violations, and increased risk of data breaches. The lack of a comprehensive, transparent, and verifiable system for data management poses significant risks for organizations, which can lead to breaches of user trust, non-compliance with regulations, and potential legal and financial repercussions.

Implementations of this disclosure address problems such as these by providing a data governance platform that incorporates a blockchain-verified data tracking system. As used herein, the term “data governance platform” may refer to a software system configured to manage, monitor, and control data-related processes and policies within an organization. The system leverages blockchain technology to create a verifiable, comprehensive, and automated audit trail for personal data across an organization's internal databases and systems. The blockchain serves as a decentralized ledger that records metadata about personal data movements and access, without storing any sensitive information itself.

In the context of the present disclosure, a “blockchain” refers to a distributed transaction ledger configured to record and verify transactions across multiple computing nodes in a decentralized manner. Accordingly, any type of distributed transaction ledger, whether it is a blockchain or some other distributed transaction ledger, may be used in implementing techniques described herein. Unlike traditional, centralized data storage solutions, a blockchain is characterized by its architecture, which stores transaction data in cryptographically linked blocks that form an immutable chain. Each block contains a cryptographic hash of the previous block, a timestamp, and transaction data, thereby securing the integrity and consistency of the ledger. The structure of blockchain inherently prevents tampering, as altering any single block would require the modification of all subsequent blocks and the consensus of the majority of participating nodes. This decentralized approach ensures that each participant, or “node,” has access to a synchronized copy of the ledger, making unauthorized alterations readily detectable.

Within the context of a privacy governance platform, a “transaction” (sometimes referred to as a “data transaction” or a “data event”) is broadly defined to encompass any action or operation performed upon data that falls under the governance of the platform. Such transactions can include, but are not limited to, the transmission of data from one entity to another, the copying or replication of data within or across systems, and any instance of data access or usage. Each of these transactions may be memorialized by a unique transaction recorded on the blockchain, allowing for a detailed and immutable record of how data is managed throughout its lifecycle. A “transaction record” refers to any information associated with a transaction that is stored for future access. For example, for each transaction associated with a set of data, a transaction record may be created and stored in a block of a blockchain. The transaction record may include any number of different types of information associated with the transaction such as, for example, a transaction identifier (ID), a data set ID, a data access type, a transaction type, an ID of an entity involved in the transaction, a timestamp, a verification indicator, a status indicator, and/or a privacy level, among other examples. By logging each transaction, the platform ensures that any access, modification, or handling of the data is verifiable and compliant with relevant data privacy standards. Consequently, this approach enables the platform to maintain a comprehensive audit trail, providing stakeholders with transparency into data usage and facilitating adherence to privacy and governance regulations.

The blockchain operates through a process wherein new transactions are verified and recorded by a consensus mechanism across the nodes in the network. Upon initiation of a transaction, nodes within the network validate the transaction according to predefined protocols and reach a consensus on its legitimacy. Once validated, the transaction is bundled with other validated transactions into a new block, which is appended to the existing chain of blocks in chronological order. The cryptographic linkage between blocks secures the transaction data, creating an immutable record of data exchanges that is distributed across all nodes. This distributed transaction ledger is well-suited for data privacy governance platforms, as it enables transparent, traceable, and verifiable tracking of data usage, access, and modifications across entities, ensuring compliance with privacy regulations and facilitating secure data governance.

Some implementations automatically update the blockchain each time personal data is copied, accessed, or moved within the organization's infrastructure. This creates a verifiable chain of custody for all personal information, enabling real-time tracking and auditing of data lineage. The blockchain record includes metadata such as timestamps, data locations, and access events, providing a complete history of how personal data has been handled.

A user interface allows authorized personnel or customers to quickly verify the location and usage of any individual's personal data across all internal systems. When a customer requests deletion of their data, the blockchain record can be used to ensure all instances are identified and removed, with the deletion events themselves recorded on the blockchain for verification. Some implementations incorporate robust access controls and encryption to ensure that only authorized parties can view or modify the blockchain records. The blockchain can be integrated with existing data management infrastructure, allowing organizations to enhance their data privacy practices without a complete overhaul of their systems.

By providing a tamper-proof, comprehensive audit trail for personal data, implementations described herein address the challenges of maintaining transparency, compliance, and user trust in data handling. Various implementations may simplify compliance efforts for regulations like the General Data Protection Regulation (GDPR) or the California Consumer Privacy Act (CCPA) by offering readily available, verifiable records of data processing activities. The ability of some implementations to provide real-time updates and automated tracking may reduce the risk of human error and oversight in data management processes. Furthermore, blockchain-verified data tracking may enhance trust between organizations and their customers by offering unprecedented transparency into how personal data is handled. Customers can be given controlled access to view an audit trail of their own data, empowering them with greater visibility and control over their personal information.

Moreover, implementations of the blockchain-verified data tracking system described herein may provide a comprehensive solution for managing personal data throughout its lifecycle, including its use in AI model training. By creating an immutable and transparent record of all data transactions, the system enables organizations to maintain a clear audit trail of how personal data is collected, processed, and utilized in AI applications. This level of visibility may help organizations demonstrate compliance with data protection regulations, such as obtaining proper consent for data usage in AI training. Additionally, the system's ability to track data lineage may assist in identifying and mitigating potential biases in AI models that could arise from the use of certain datasets. By implementing this blockchain-based approach, organizations may foster greater trust with their customers and stakeholders, as they can provide verifiable evidence of responsible data handling practices in AI development and deployment.

In some examples of this disclosure, implementations may include or otherwise use one or more AI or machine learning (ML) (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

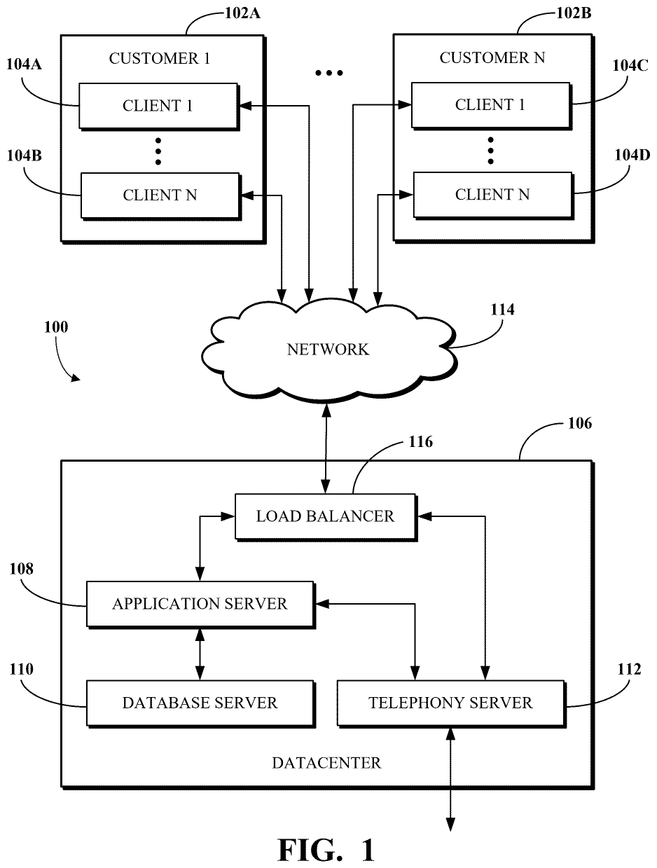

To describe some implementations in greater detail, reference is first made to examples of hardware and software structures used to implement a system for blockchain-verified data tracking. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

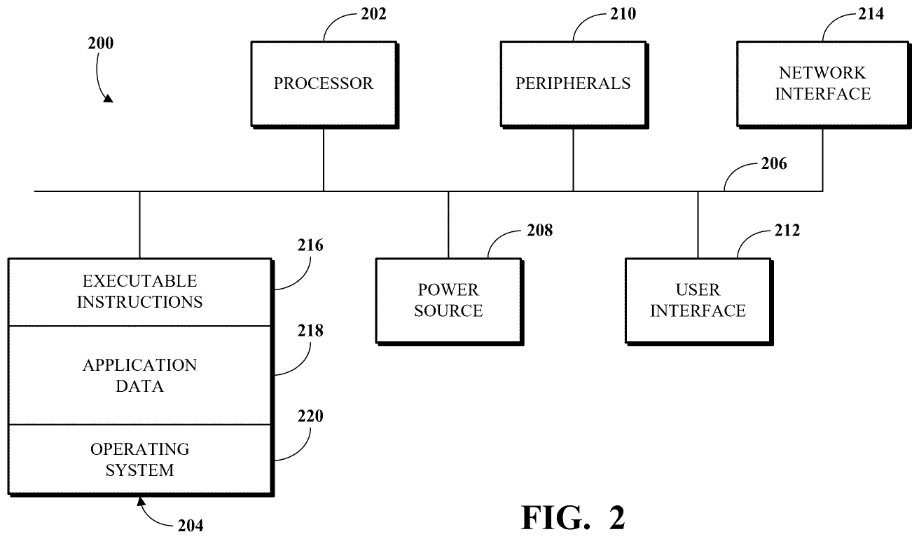

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

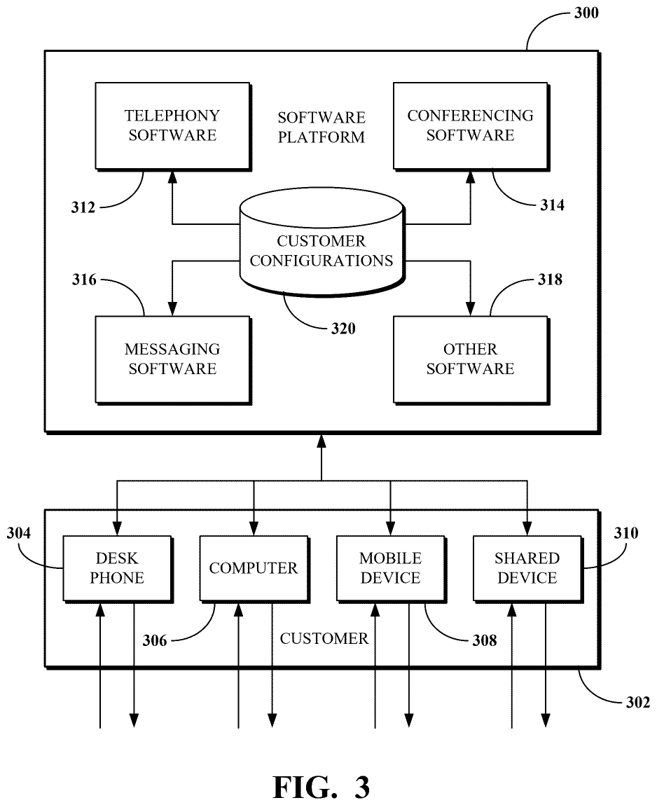

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients - a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for implementing a data governance platform, software for implementing a schema registry system, and/or software for implementing a development pipeline. In some such cases, the other software 318 may operate as a centralized service accessed by or using the telephony software 312, the conferencing software, and/or the messaging software 316. In other such cases, the telephony software 312, the conferencing software, and/or the messaging software 316 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

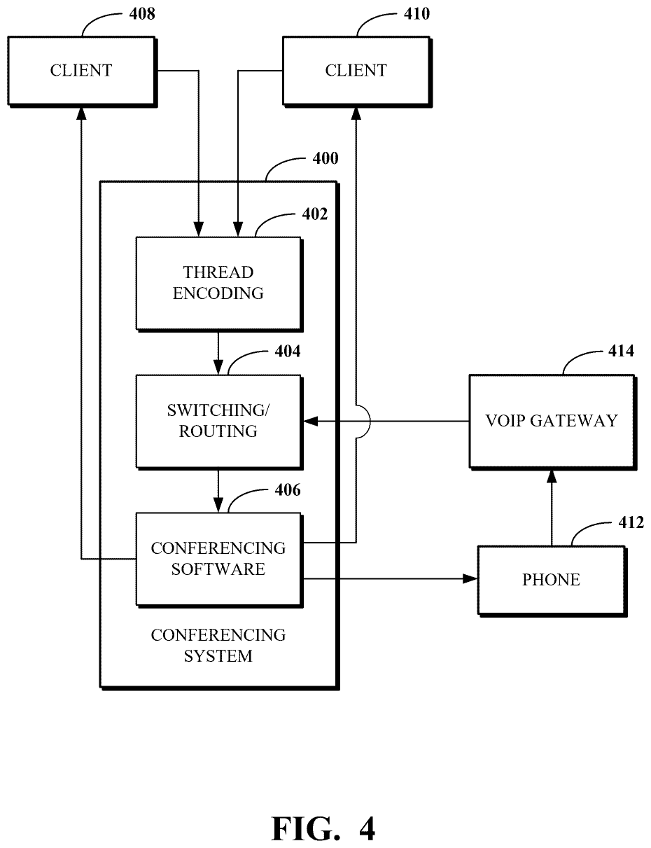

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

In some implementations, a blockchain-verified data tracking system may be used with the conferencing software 406 to facilitate data privacy management associated therewith. For example, the conferencing software 406 may include a blockchain node application. The blockchain node application may be included in the conferencing software and may be configured to facilitate blockchain-verified data tracking to facilitate data privacy management.

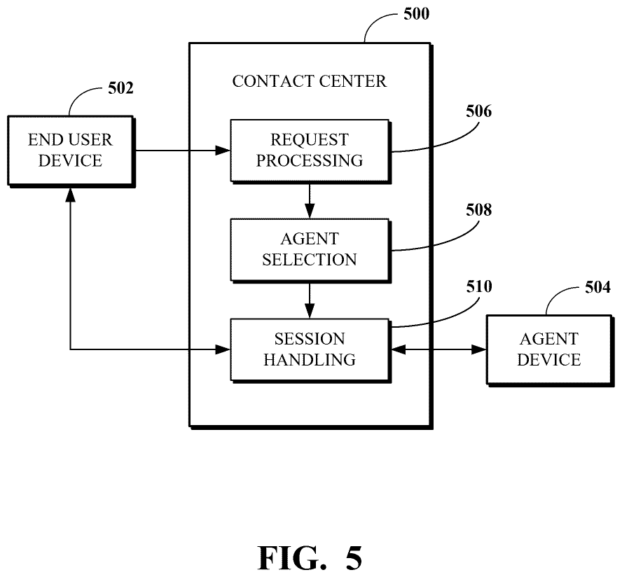

FIG. 5 is a block diagram of an example of a contact center system. A contact center 500, which in some cases may be implemented in connection with a software platform (e.g., the software platform 300 shown in FIG. 3), is accessed by a user device 502 and used to establish a connection between the user device 502 and an agent device 504 over one of multiple modalities available for use with the contact center 500, for example, telephony, video, text messaging, chat, and social media. The contact center 500 is implemented using one or more servers and software running thereon. For example, the contact center 500 may be implemented using one or more of the servers 108 through 112 shown in FIG. 1 and may use communication software such as or similar to the software 312 through 318 shown in FIG. 3. The contact center 500 includes software for facilitating contact center engagements requested by user devices such as the user device 502. As shown, the software includes request processing software 506, agent selection software 508, and session handling software 510.

The request processing software 506 processes a request for a contact center engagement initiated by the user device 502 to determine information associated with the request. The request may include a natural language query or a request entered in another manner (e.g., “press 1 to pay a bill, press 2 to request service”). The information associated with the request generally includes information identifying the purpose of the request and which is usable to direct the request traffic to a contact center agent capable of addressing the request. The information associated with the request may include information obtained from a user of the user device 502 after the request is initiated. For example, for the telephony modality, the request processing software 506 may use an interactive voice response (IVR) menu to prompt the user of the user device to present information associated with the purpose of the request, such as by identifying a category or sub-category of support requested. In another example, for the video modality, the request processing software 506 may use a form or other interactive user interface to prompt a user of the user device 502 to select options which correspond to the purpose of the request. In yet another example, for the chat modality, the request processing software 506 may ask the user of the user device 502 to summarize the purpose of the request (e.g., the natural language query) via text and thereafter process the text entered by the user device 502 using natural language processing and/or other processing.

The session handling software 510 establishes a connection between the user device 502 and the agent device 504, which is the device of the agent selected by the agent selection software 508. The particular manner of the connection and the process for establishing same may be based on the modality used for the contact center engagement requested by the user device 502. The contact center engagement is then facilitated over the established connection. For example, facilitating the contact center engagement over the established connection can include enabling the user of the user device 502 and the selected agent associated with the agent device 504 to engage in a discussion over the subject modality to address the purpose of the request from the user device 502. The facilitation of the contact center engagement over the established connection can use communication software implemented in connection with a software platform, for example, one of the software 312 through 318, or like software.

The user device 502 is a device configured to initiate a request for a contact center engagement which may be obtained and processed using the request processing software 506. In some cases, the user device 502 may be a client device, for example, one of the clients 304 through 310 shown in FIG. 3. For example, the user device 502 may use a client application running thereat to initiate the request for the contact center engagement. In another example, the connection between the user device 502 and the agent device 504 may be established using software available to a client application running at the user device 502. Alternatively, in some cases, the user device 502 may be other than a client device.

The agent device 504 is a device configured for use by a contact center agent. Where the contact center agent is a human, the agent device 504 is a device having a user interface. In some such cases, the agent device 504 may be a client device, for example, one of the clients 304 through 310, or a non-client device. In some such cases, the agent device 504 may be a server which implements software usable by one or more contact center agents to address contact center engagements requested by contact center users. Where the contact center agent is a non-human, the agent device 504 is a device that may or may not have a user interface. For example, in some such cases, the agent device 504 may be a server which implements software of or otherwise usable in connection with the contact center 500.

Although the request processing software 506, the agent selection software 508, and the session handling software 510 are shown as separate software components, in some implementations, some or all of the request processing software 506, the agent selection software 508, and the session handling software 510 may be combined. For example, the contact center 500 may be or include a single software component which performs the functionality of all of the request processing software 506, the agent selection software 508, and the session handling software 510. In some implementations, one or more of the request processing software 506, the agent selection software 508, or the session handling software 510 may be comprised of multiple software components. In some implementations, the contact center 500 may include software components other than the request processing software 506, the agent selection software 508, and the session handling software 510, such as in addition to or in place of one or more of the request processing software 506, the agent selection software 508, and the session handling software 510.

In some implementations, a blockchain-verified data tracking system may be used with the contact center 500 to facilitate data privacy management associated therewith. For example, the contact center 500 may include a blockchain node application. The a blockchain node application may be configured to facilitate blockchain-verified data tracking to facilitate data privacy management. Additionally, agent devices 504 may include blockchain node applications.

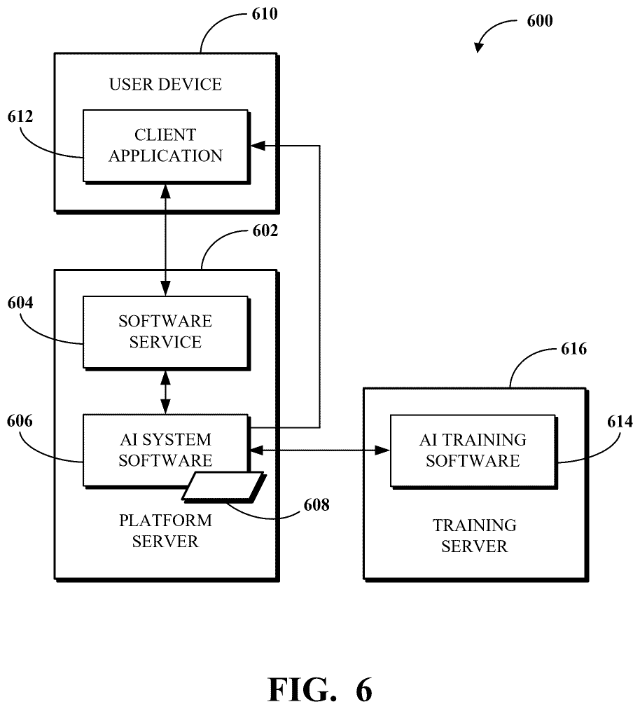

FIG. 6 is a block diagram of an example of an AI system 600 for processing user requests associated with software services of a software platform, such as the software platform 300 shown in FIG. 3. The AI system 600 includes a platform server device 602 (shown as “platform server”) that implements a software service 604, AI system software 606, and one or more machine learning models 608 such as one or more LLMs. For example, the platform server device 602 may include one or more application servers and/or database servers, such as the application server 108 and the database server 110 shown in FIG. 1, used to implement the software service 604, the AI system software 606, and the one or more machine learning models 608. In some cases, the platform server device 602 may be or otherwise include multiple servers. In such a case, the software service 604, the AI system software 606, and the one or more machine learning models 608 may be implemented across the multiple servers in one or more ways.

The software service 604 is, includes, or otherwise refers to the components used to run (e.g., execute or interpret) application-level software. For example, the software service 604 may facilitate synchronous or asynchronous communications, such as via one of the software services 312 through 316 shown in FIG. 3. In another example, the software service 604 may facilitate functionality directly related, indirectly related, or unrelated to synchronous or asynchronous communications, such as appointment scheduling, event hosting, knowledgebase compilation, digital whiteboarding, workspace reservation, and the like. The software service 604 may thus be one of many software services of the software platform, in which some or all of those other software services may also be implemented by the platform server device 602 or by one or more other server devices associated with the software platform.

The software service 604 is accessed by a user device 610, which is a personal or shared computing device configured to run a client application 612 associated with the software service 604. For example, the user device 610 may be one of the clients 304 through 310 shown in FIG. 3. The client application 612 may be a software application installed on the user device 610 and used to access the various software services of the software platform via one or more client-side graphical user interfaces (GUIs). Alternatively, the client application 612 may be a web-based application instantiated based on requests processed in connection with a web browser running at the user device 610. In some implementations, the client application 612 may be omitted, in which case the user device 610 may instead access the software service 604 using other web browser-based approaches or a different software application.

In one non-limiting example, the software service 604 may correspond to conferencing software (e.g., the conferencing software 314 shown in FIG. 3) for facilitating video conferences between users of user devices including the user device 610. The user of the user device 610 connects to the video conference via the client application 612, which interfaces with the software service 604 to cause the user device 610 to join the video conference and thus enable synchronous communications over video and/or audio with the users of the other user devices. For example, the client application 612 may encode a video stream captured at the user device 610 and transmit the encoded video stream for rendering at the other user devices, and it may similarly receive encoded video streams originating at those other user devices and decode same to render the video of the other user device users at the user device 610. The user of the user device 610 may similarly use the client application 612 to access related functionality of the video conference, for example, chat tools for interacting with one or more participants via text, AI tools for summarizing video conference content, and the like.

The software service 604 may receive user requests initiated at the user device 610. The user requests are related to functionality of the software service 604 and correspond to tasks to be actioned by or otherwise on behalf of the software service 604, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 610 in one or more ways, including, for example, by the user device 610 obtaining input from a user thereof, such as in response to a prompt.

The AI system software 606 obtains such a user request from the software service 604 and causes the one or more machine learning models 608 to process the user request to produce output responsive to the user request. The AI system software 606 then transmits the output to the software service 604 for the software service 604 to present to the user device 610. In particular, the AI system software 606 orchestrates the execution of the one or more machine learning models 608 as part of a model chain by causing the one or more machine learning models 608, in sequence, to perform an inference operation to produce output based on the user request.

In some implementations, the AI system software 606 may cause an execution of one or more machine learning models 608 at the user device 610. For example, the client application 612 may include or otherwise obtain (e.g., download from a source external to the user device 610) executable instructions for implementing a machine learning model at the user device 610. In some such implementations, the one or more machine learning models implemented at the user device 610 may be the first machine learning models of the model chain. Thus, server-side user request traffic may in such cases be avoided or at least limited based on the processing of user requests being handled at the client-side.

The one or more machine learning models 608 may include a trained policy model. The trained policy model may be an LLM trained using AI training software 614 implemented on a training server 616. In some implementations, the training server 616 may be, be similar to, include, or be included in, the platform server device 602. In some other implementations, the training server 616 may be distinct from the platform server device 602. The training server 616 may refer to any number of server devices and/or server instances. In some implementations, the training server 616 may refer to a federated training system. The training server 616 may include one or more servers, such as the application server 108 and the database server 110 shown in FIG. 1. In some implementations, the training server 616 may implement preference optimization software for training the one or more machine learning models 608.

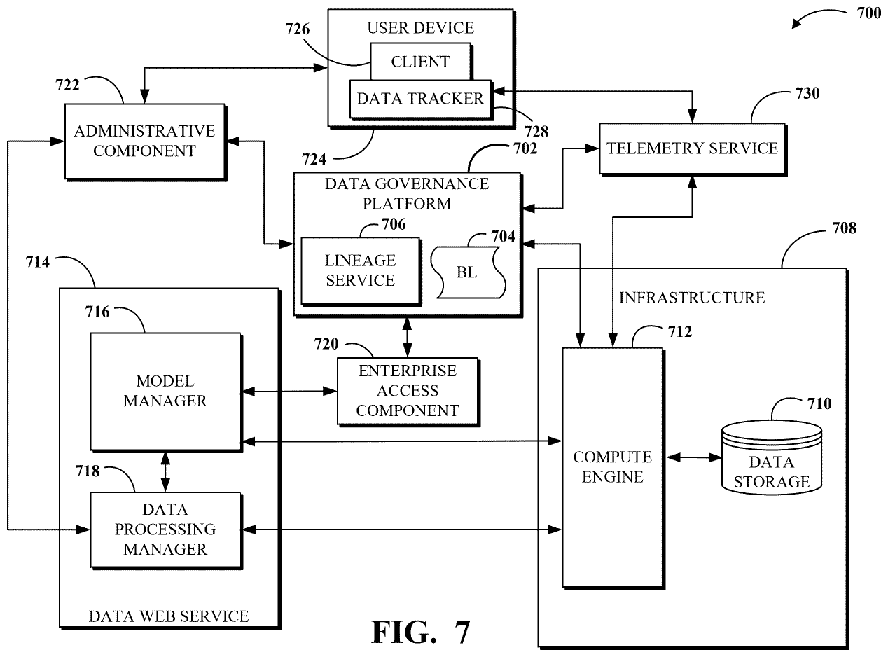

FIG. 7 is a block diagram of an example of a system 700 for implementing data privacy management. The system 700 may be configured for addressing technical problems such as those related to maintaining data privacy and compliance in complex, distributed computing environments. The system 700 provides a technical solution by integrating various components to track, manage, and control data flow and access across multiple services and devices.

As shown, the system 700 includes a data governance platform 702. The data governance platform 702 may be, be similar to, include, or be included in the platform server device 602 shown in FIG. 6, the contact center 500 shown in FIG. 5, the conferencing system 400 shown in FIG. 4, the software platform 300 shown in FIG. 3, the computing device 200 shown in FIG. 2, and/or the datacenter 106 shown in FIG. 1, among other examples. The data governance platform 702 may include various components and services designed to ensure data quality, security, and compliance. For example, the data governance platform 702 may implement data classification algorithms, access control mechanisms, and audit logging capabilities.

The data governance platform 702 includes a lineage service 706 configured to manage data tracking operations. For example, the lineage service 706 may be configured to perform one or more aspects of a process of blockchain-verified data tracking, as described herein. In some implementations, for example, the lineage service 706 may generate, update, maintain, distribute, and/or otherwise manage a blockchain ledger 704 (shown in FIG. 7 as “BL”). The blockchain ledger 704 may be configured to track a lineage of data that may be subject to privacy protections. In some implementations, the blockchain ledger 704 may refer to any number of different types of distributed transaction ledgers.

In some implementations, the blockchain ledger 704 may serve as a data map that tracks a lineage of data that may be subject to data privacy protections. In some implementations, the blockchain ledger 704 may be implemented in addition to, or in lieu of, a data map that is distinct from the blockchain ledger 704. For example, in some implementations, the blockchain ledger 704 may be used as a data source and/or a verification source for a data map. In some implementations, the blockchain ledger 704 may be used in addition to a data map as part of an optional (e.g., enhanced) service offering associated with the data governance platform. In some implementations, the blockchain ledger 704 may include some or all of the information included in a data map and/or vice versa.

A lineage of a set of data may refer to information indicative of an origin of the set of data, movement of the set of data (from one device to another), any relationships between the set of data and other data or processes, any access to the set of data, any transformation of the set of data, and/or any copying of the set of data, among other examples. The lineage service 706 may be configured to obtain data event information indicative of a data event associated with a set of data. The data event information may comprise a set of metadata corresponding to the set of data. The set of metadata may include location information associated with at least one location of the set of data. For example, the location information may include a physical address associated with the at least one location of the set of data, a network address associated with the at least one location of the set of data, or both. The lineage service 706 may be configured to generate or update a data map and/or the blockchain ledger 704 based on the location information. The set of metadata may also include a data source identifier associated with the set of data, a data classification associated with the set of data, a data access permission associated with the set of data, or a combination thereof. For example, when a user uploads a file to the system, the lineage service 706 may record metadata such as the file size, upload time, source IP address, and destination storage location. The data map and/or the blockchain ledger 704 may include information such as physical or network addresses of data storage locations, data movement paths, and data access patterns. For instance, the data map and/or the blockchain ledger 704 may track how a particular dataset moves from a user device through various processing stages and ultimately to long-term storage.

In some implementations, the lineage service 706 may be a part of a blockchain-verified data tracking system, which may be implemented using various blockchain solutions to enhance data privacy and security, as described herein.

In some implementations, a selectively masked blockchain solution may be implemented to regulate access to transaction records stored within the blockchain. In this approach, certain fields or portions of the blockchain may be selectively encrypted or redacted based on user roles and permissions. For example, sensitive personal information may be masked for general users but visible to authorized personnel. This selective masking may be achieved through the use of cryptographic techniques such as zero-knowledge proofs or homomorphic encryption. The masking may be dynamic, allowing for real-time adjustments to data visibility based on changing access rights or regulatory requirements. This solution may provide a balance between transparency and privacy, ensuring that only authorized parties can view sensitive information while maintaining the integrity of the blockchain.

In some implementations, the selective masking may be applied at different granularity levels, from individual data fields to entire blocks. For example, the lineage service 706 may maintain a separate access control list that determines which users or roles can view specific parts of the blockchain. When a user queries the blockchain, the system 700 may apply the appropriate masks before returning the results. This approach may allow for fine-grained control over data access while preserving the blockchain's immutability and auditability. The selectively masked blockchain may also incorporate time-based access controls. For instance, certain data may be automatically unmasked after a specified period (e.g., to facilitate verification of a requestor's identity prior to data deletion in response to a data deletion request), aligning with data retention policies or regulatory requirements. This feature may be particularly useful for managing time-sensitive information or implementing “right to be forgotten” requests in compliance with privacy regulations.

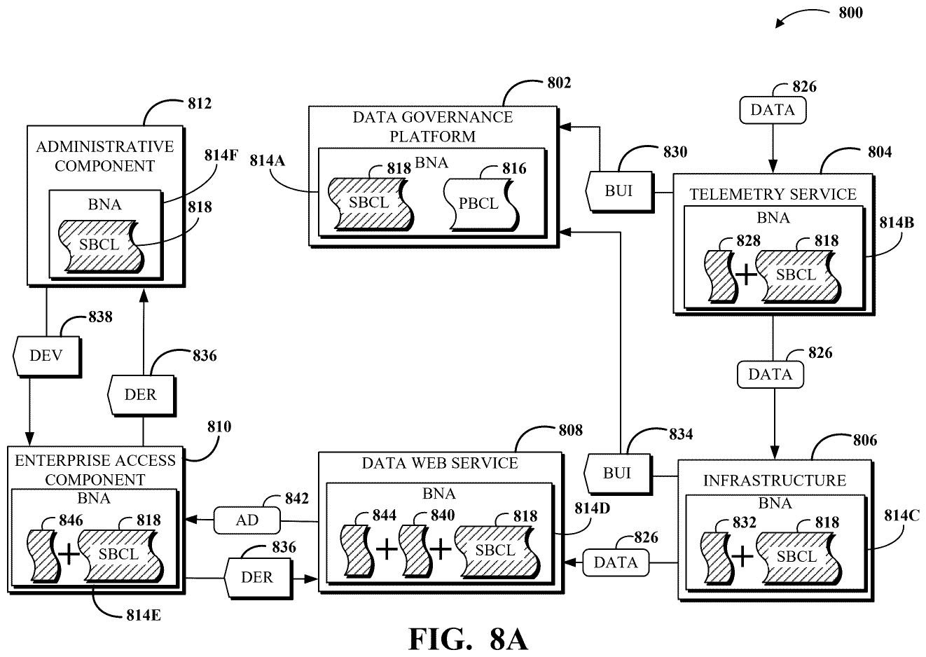

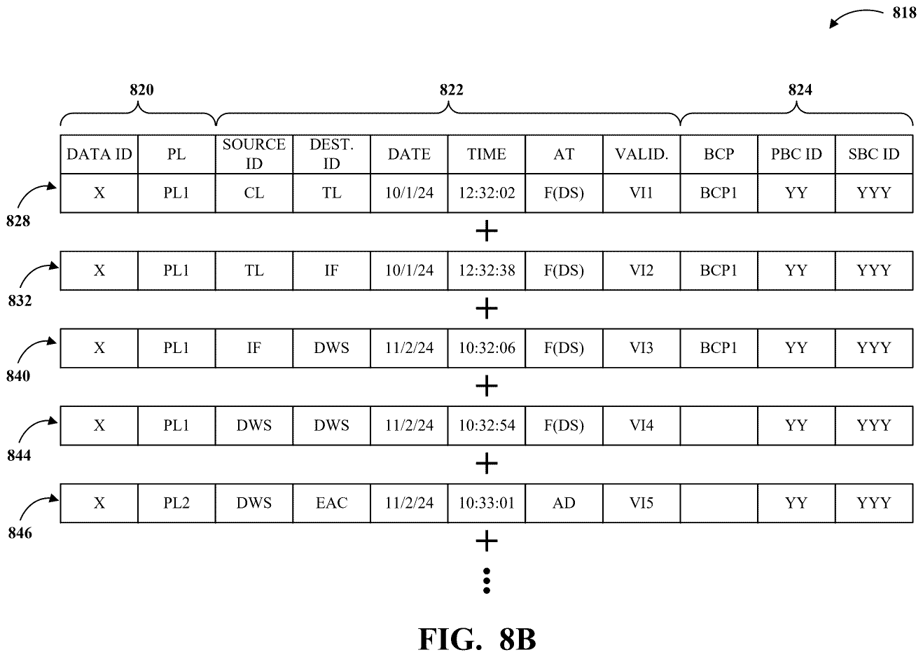

Another blockchain solution may involve the use of a primary blockchain ledger and one or more secondary blockchain ledgers, as described in further detail below in connection with FIGS. 8A and 8B. In this architecture, the primary blockchain may contain a comprehensive record of all data transactions, while secondary blockchains may store subsets of data or metadata relevant to specific departments, services, or data types. Certain nodes in the network may only be given access to the secondary blockchain ledgers, providing an additional layer of data segregation and access control.

In some implementations, the primary blockchain ledger may serve as the authoritative source of truth for the entire system, maintained by a set of trusted nodes with high security clearance. It may contain detailed records of all data movements, access events, and modifications. Secondary blockchain ledgers, on the other hand, may be tailored to specific use cases or user groups. For example, a secondary blockchain may be dedicated to tracking customer data for a particular service, containing only the relevant subset of transaction records from the primary blockchain.

This multi-ledger approach may offer several advantages. It may allow for more efficient querying and processing of relevant data by different parts of the organization. It may also enhance privacy by limiting the exposure of sensitive information to only those nodes that require access. Additionally, this structure may facilitate compliance with data localization requirements by allowing certain secondary blockchains to be geographically restricted.

The relationship between the primary and secondary blockchains may be managed through various mechanisms. For instance, the system 700 may employ Merkle trees to create verifiable links between the ledgers, allowing for efficient proof of inclusion without revealing the entire contents of the primary blockchain. Regular synchronization processes may ensure that secondary blockchains remain up-to-date with relevant information from the primary blockchain.

Another blockchain solution may involve using a blockchain permission value stored within the blockchain itself to control access to corresponding data sets. In this approach, each block or transaction in the blockchain may include a permission value that determines who can access the associated data. This permission value may be cryptographically secured and may only be modifiable through consensus mechanisms or by authorized parties.

The blockchain permission value may be implemented as a smart contract that governs access to the data. When a user or system attempts to access data referenced in the blockchain, the smart contract may evaluate the requester's credentials against the stored permission value. If the requester meets the required criteria, access may be granted; otherwise, it may be denied. This approach may allow for dynamic and granular access control directly embedded within the blockchain structure. In some implementations, the permission value may be a complex data structure that encodes multiple levels of access rights. For example, it may specify read, write, or delete permissions for different user roles or even individual users. The permission value may also include temporal constraints, allowing access only during specific time windows or under certain conditions.

The blockchain permission value system may be particularly useful for managing data access in decentralized environments. It may allow for transparent and auditable access control without relying on a centralized authority. Moreover, changes to permission values may be recorded as transactions on the blockchain, providing a clear history of how access rights have evolved over time. This solution may also facilitate the implementation of data subject rights under privacy regulations. For instance, when a user requests the deletion of their data, the system may update the permission values associated with that user's data to revoke all access. This may effectively render the data inaccessible without physically deleting it from the blockchain, preserving the blockchain's immutability while complying with privacy requests.

The blockchain permission value may be used in conjunction with off-chain storage systems. In such cases, the blockchain may store only the permission values and references to the actual data, which may be stored in separate databases or cloud storage systems. This hybrid approach may combine the security and transparency benefits of blockchain with the scalability and performance advantages of traditional storage systems.

In some implementations, the data governance platform 702 may be configured to respond to queries associated with data location. In some implementations, the data governance platform 702 may automate personal data audits and telemetry privacy impact assessments. For example, the data governance platform 702 may receive a data location query indication associated with the set of data. The data location query indication may be a PIA request associated with the set of data, a data subject access request (DSAR) associated with the set of data, a data subject deletion request (DSDR) associated with the set of data, a data protection impact assessment (DPIA) associated with the set of data, or another type of request. The data governance platform 702 may provide, for output and based on the data location query indication and a data map and/or the blockchain ledger 704, a query result. The query result may include a PIA report, a DSAR report, a DSDR report, or another type of report. In some implementations, an engineer or an engineering software component may request collection of data and/or access to collected data. The data governance platform 702 may, responsive to the request for collection and/or access, prompt the engineer or the engineering software component to fill out a PIA form, which may be provided to a privacy officer or a software component to review which data can be collected, approved usages of the collected data, and the like. In some implementations, the data location query may be associated with a data collection categorization operation and/or a data classification operation according to sensitivity levels.

The system 700 also includes an infrastructure 708. The infrastructure 708 provides the underlying computing resources for the system 700. The infrastructure 708 may be, be similar to, include, or be included in the platform server device 602 shown in FIG. 6, the software platform 300 shown in FIG. 3, the computing device 200 shown in FIG. 2, and/or the datacenter 106 shown in FIG. 1, among other examples. In some implementations, the infrastructure 708 (or a portion thereof) may be provided by the same business entity that provides the data governance platform 702, and in some implementations, the infrastructure 708 (or a portion thereof) may be provided by a different business entity than the business entity that provides the data governance platform 702.

A data storage component 710 within the infrastructure 708 may be configured to store various types of data, including user data, system logs, and metadata. The data storage component 710 may implement different storage technologies based on data sensitivity and access requirements. For example, highly sensitive data may be stored in encrypted form on isolated storage systems, while less sensitive data may be stored in more accessible cloud storage solutions.

A compute engine 712 of the infrastructure 708 may be responsible for executing data processing tasks and computations required by other components of the system 700. For instance, the compute engine 712 may perform data anonymization operations, run ML models for data classification, or execute complex queries on large datasets. In some implementations, the compute engine 712 may utilize distributed computing techniques to process data in parallel across multiple nodes for improved performance.

The system 700 also includes a data web service 714 that includes a model manager 716 and a data processing manager 718. The data web service 714 may be, be similar to, include, or be included in the platform server device 602 shown in FIG. 6, the software platform 300 shown in FIG. 3, the computing device 200 shown in FIG. 2, and/or the datacenter 106 shown in FIG. 1, among other examples. In some implementations, the data web service 714 (or a portion thereof) may be provided by the same business entity that provides the data governance platform 702, and in some implementations, the data web service 714 (or a portion thereof) may be provided by a different business entity than the business entity that provides the data governance platform 702. In some implementations, the data web service 714 (or a portion thereof) may be, be similar to, include, or be included in the infrastructure 708.

In some implementations, the data web service 714 acts as an interface between the data governance platform 702 and other components of the system 700. The model manager 716 within the data web service 714 may be responsible for managing ML models used for data classification, anomaly detection, and/or privacy risk assessment. For example, the model manager 716 may periodically update these models based on new training data and/or changing privacy regulations. In some implementations, retrieval-augmented generation (RAG) may be used to obtain domain-specific content for identifying privacy regulation changes. In some implementations, the data web service 714 may facilitate access to AI/ML technologies for use by any number of employees and/or services in an enterprise. The enterprise may include the data governance platform 702 and/or may be provided data governance services via the data governance platform 702.

The data processing manager 718 of the data web service 714 may orchestrate data processing workflows across the system 700. It may receive data processing requests, coordinate with the compute engine 712 for execution, and ensure that all data handling complies with any policies, rules, and/or data flows defined in the data governance platform 702. In some implementations, data retention and/or data deletion policies may be managed by the data processing manager 718 (e.g., in conjunction with the data governance platform 702). For instance, when processing a large dataset for analysis, the data processing manager 718 may first check data access permissions, apply necessary data masking techniques, and then distribute the processing tasks across available compute resources (e.g., provided by the compute engine 712).

The system 700 also includes an enterprise access component 720. The enterprise access component 720 provides a secure gateway for enterprise users to interact with the system 700 or one or more components thereof. The enterprise access component 720 may implement authentication and authorization mechanisms to ensure that only authorized personnel can access sensitive data and/or perform certain operations. For example, the enterprise access component 720 may use multi-factor authentication and role-based access control to manage user permissions. In some implementations, a least privilege access rule may be applied. In such cases, the authorized personnel may have only the minimal level of access (permissions) necessary to perform their functions.

In some implementations, the enterprise access component 720 may be, be similar to, include, or be included in the platform server device 602 shown in FIG. 6, the software platform 300 shown in FIG. 3, the computing device 200 shown in FIG. 2, and/or the datacenter 106 shown in FIG. 1, among other examples. In some implementations, the enterprise access component 720 (or a portion thereof) may be provided by the same business entity that provides the data governance platform 702, and in some implementations, the enterprise access component 720 (or a portion thereof) may be provided by a different business entity than the business entity that provides the data governance platform 702. In some implementations, the enterprise access component 720 (or a portion thereof) may be, be similar to, include, or be included in the infrastructure 708 and/or the data web service 714.

The enterprise access component 720 may facilitate access to the data web service 714 by employees of the business entity that provides the data governance platform 702. The enterprise access component 720 may be associated with a business entity other than the business entity that provides the data governance platform 702, in which case the enterprise access component 720 may work with the data governance platform 702 to manage data privacy associated with data compute jobs performed via the enterprise access component 720 and the data web service 714. In such an implementation, the data governance platform 702 may be provided as a service to one or more customers.

The system 700 also includes an administrative component 722. The administrative component 722 may offer interfaces for system administrators to configure and/or monitor the data governance platform 702. Through this component, administrators may define data classification rules, set up data retention policies, set up data deletion policies (e.g., to be executed at account termination or user termination), and/or configure PIA workflows. The administrative component 722 may provide the data classification rules, the data retention policies and/or the data deletion policies to the data governance platform 702 for incorporation with a data map and/or the blockchain ledger 704 and lineage service 706. The administrative component 722 may also provide dashboards and/or reports to help administrators identify potential privacy risks or compliance issues.

In some implementations, the administrative component 722 may be, be similar to, include, or be included in the platform server device 602 shown in FIG. 6, the software platform 300 shown in FIG. 3, the computing device 200 shown in FIG. 2, and/or the datacenter 106 shown in FIG. 1, among other examples. In some implementations, the administrative component 722 (or a portion thereof) may be provided by the same business entity that provides the data governance platform 702, and in some implementations, the administrative component 722 (or a portion thereof) may be provided by a different business entity than the business entity that provides the data governance platform 702. In some implementations, the administrative component 722 (or a portion thereof) may be, be similar to, include, or be included in the enterprise access component 720, the data governance platform 702, the infrastructure 708 and/or the data web service 714. In some implementations, the administrative component 722 may facilitate access to the data governance platform 702 and/or the data processing manager 718 by a user device 724.

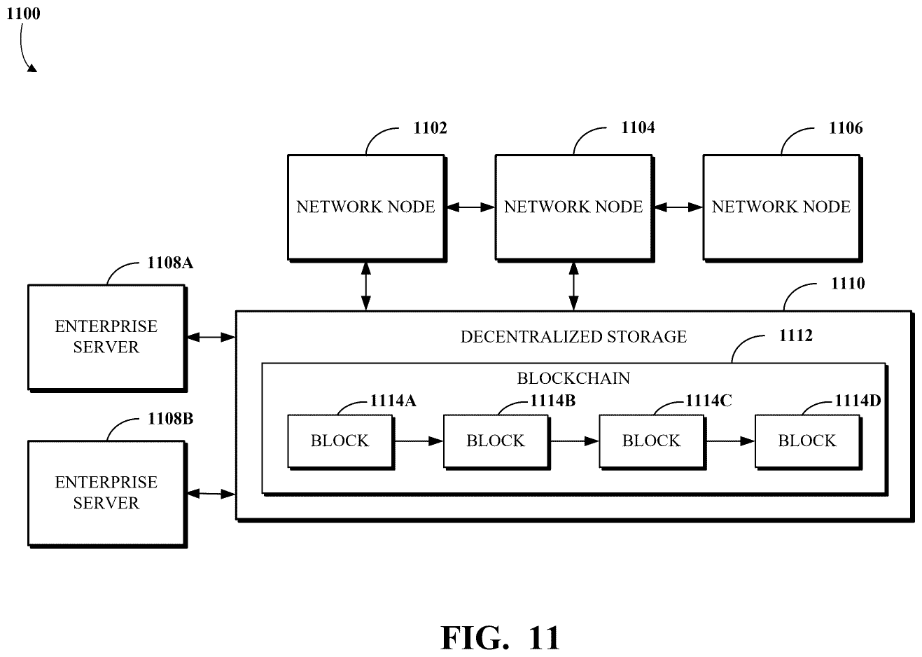

The user device 724 represents an endpoint where data may be generated, accessed, and/or modified. The user device 724 may be a client device, such as a mobile phone, a tablet computer, a laptop computer, a notebook computer, a desktop computer, or another suitable computing device or combination of computing devices. The user device 724 may be, be similar to, include, or be included in user device 610 shown in FIG. 6; the end network node 1102 in FIG. 11 or the agent device 504 shown in FIG. 5; the client 408, the client 410, or the phone 412 shown in FIG. 4; the desk phone 304, the computer 306, the mobile device 308, or the shared device 310 shown in FIG. 3; the computing device 200 shown in FIG. 2; and/or the customer 1102A, the customer N 102B, the client 1 104A, the client N 104B, the client 1 104C, and/or the client N 104D shown in FIG. 1, among other examples.

The user device 724 includes a client application 726 and a data tracker 728. The client application 726 is a software application installed on the user device 724 and may be used to access various services of the system 700 via one or more client-side GUIs. The client application 726 may provide a user interface for interacting with the system, such as uploading files, requesting data access, and/or viewing privacy notices, among other examples. The client application 726 may be, be similar to, include, or be included in the client application 612 shown in FIG. 6; and/or the client 1 104A, the client N 104B, the client 1 104C, and/or the client N 104D shown in FIG. 1, among other examples.

The data tracker 728 is a software component configured to track telemetry data. The data tracker 728 within the user device 724 may monitor local data activities and report relevant events to the telemetry service 730. For instance, the data tracker 728 may log when a user accesses a sensitive document or attempts to share data outside the organization. In some implementations, an engineer or an engineering software component may request a data collection operation via the telemetry service 730. In response, the data governance platform 702 may prompt the engineer to fill out a PIA form or may request an automated PIA form from the engineering software component. The data governance platform 702 may provide the PIA form to a privacy officer or a software component to review.

The telemetry data may be provided to a telemetry service 730. The telemetry service 730 may collect and process data from various sources within the system 700, including the data tracker 728 on user devices. The telemetry service 730 may aggregate and/or analyze telemetry data to identify usage patterns, detect potential security threats, and/or measure compliance with data handling policies, among other examples. For example, the telemetry service 730 may generate alerts if it detects unusual data access patterns that could indicate a potential data breach. The telemetry service 730 may be, be similar to, include, or be included in the platform server device 602 shown in FIG. 6, the software platform 300 shown in FIG. 3, the computing device 200 shown in FIG. 2, and/or the datacenter 106 shown in FIG. 1, among other examples. In some implementations, the telemetry service 730 (or a portion thereof) may be provided by the same business entity that provides the data governance platform 702, and in some implementations, the telemetry service 730 (or a portion thereof) may be provided by a different business entity than the business entity that provides the data governance platform 702.

In some implementations, the system 700 may also be used to identify a data schema associated with a registration request corresponding to a telemetry event. A classification operation associated with the telemetry event may be performed based on the data schema, which may involve obtaining a set of classification labels associated with the telemetry event. A privacy impact assessment associated with the telemetry event may be performed based on the set of classification labels. An event registration indication associated with the telemetry event may be provided for output based on the privacy impact assessment.

The system 700 may be used to address a number of challenges associated with data privacy management in the context of modern software systems. The system 700 provides enhanced visibility into data flows and locations, enabling organizations to maintain accurate and up-to-date knowledge of where sensitive information resides and how it is being used. This visibility may facilitate complying with data protection regulations and responding effectively to DSARs and/or DSDRs.

The system 700 also offers significant advantages in terms of automation and efficiency. By integrating data governance, processing, and monitoring components, the system 700 can automate many aspects of data privacy management, reducing the need for time-consuming manual processes. For instance, the system 700 can automatically classify new datasets, apply appropriate access controls, and track data lineage without requiring constant human intervention.

The system 700 may automate the review process for data classification, trigger compliance reviews, and provide a feedback loop for approvals. The system 700 may also provide, for display as part of a GUI, data configured to cause the GUI to present a dashboard comprising information associated with at least one of a data privacy compliance assessment, a data privacy risk, a set of data assets, a data classification scan operation, a data classification labeling operation, and/or a data subject request, among other examples.

The system 700 also addresses the challenge of ensuring compliance with evolving data protection regulations. The system 700 may automatically perform a data privacy compliance assessment, generate, based on the data privacy compliance assessment, a task associated with a data privacy compliance gap, and provide an indication of the task to a software service. The system 700 may also be used to configure a set of data privacy policies based on the blockchain ledger 704. The system 700 may also perform an automated audit operation on a data privacy policy based on a time-based trigger event, and re-configuring the data privacy policy based on the automated audit operation.

Furthermore, the system's ability to perform real-time monitoring and analysis through components like the telemetry service 730 and the lineage service 706 enables proactive risk management. Organizations can quickly identify and address potential privacy issues before they escalate into more serious problems, thereby reducing the risk of data breaches and regulatory violations.

FIGS. 8A and 8B illustrate an example associated with blockchain-verified data tracking, as described herein. FIG. 8A is a schematic block diagram of an example system 800 for blockchain-verified data tracking in a data governance platform. In some implementations, the system 800 may be, be similar to, include, or be included in the system 700. For example, the system 800 includes a data governance platform 802, which may serve as a central component for managing and tracking personal data. In some implementations, the data governance platform 802 may be, be similar to, include, or be included in the data governance platform 702 shown in FIG. 7. The data governance platform 802 may be implemented using one or more servers, such as application servers or database servers, and may include software components designed to ensure data quality, security, and compliance. For example, the data governance platform 802 may implement data classification algorithms, access control mechanisms, and audit logging capabilities.

The data governance platform 802 interacts with several other components, including a telemetry service 804, an infrastructure 806, a data web service 808, an enterprise access component 810, and an administrative component 812. These components work together to manage the flow and tracking of personal data within the system 800. In some implementations, the telemetry service 804, the infrastructure 806, the data web service 808, the enterprise access component 810, and the administrative component 812 may be, be similar to, include, or be included in the telemetry service 730, the infrastructure 708, the data web service 714, the enterprise access component 720, or the administrative component 722, respectively, shown in FIG. 7.

The system 800 incorporates multiple blockchain node applications (BNAs) 814A-814F, which are distributed across the various components 802, 804, 806, 808, 810, and 812. In some implementations, a component that includes a BNA 814 (one of the BNAs 814A-814F) may be considered to be a blockchain node. The blockchain nodes maintain and update the blockchain ledgers used for data tracking. The system 800 includes both a primary blockchain ledger (PBCL) 816 and a secondary blockchain ledger (SBCL) 818. The multi-ledger approach shown in FIGS. 8A and 8B may offer several benefits, such as allowing for more efficient querying and processing of relevant data by different parts of the organization and enhancing privacy by limiting the exposure of sensitive information to only those nodes that require access.

In some implementations, the PBCL 816 may serve as the authoritative source of truth for the entire system 800, maintained by a set of trusted nodes with high security clearance. The PBCL 816 may contain detailed records of all data movements, access events, and modifications. The SBCL 818, on the other hand, may be tailored to specific use cases or user groups. For example, the SBCL 818 may be dedicated to tracking customer data for a particular service, containing only the relevant subset of transaction records from the PBCL 816.

As shown in FIG. 8B, the SBCL 818 includes data-specific fields 820, transaction-specific fields 822, and blockchain-specific fields 824. When a block is generated, one or more of the data fields may be populated to provide a transaction record associated with a data transaction. The data-specific fields 820 may include values specific to a data set. For example, as shown in FIG. 8B, the data-specific fields may include a data identifier (ID) field and a privacy level field. The data ID field may include a value that identifies a data set associated with the data transaction and the privacy level field may include a value that identifies a privacy level associated with the data. The privacy level field may contain specific values designating the sensitivity or classification of the data set, effectively guiding the governance platform 802 in regulating data flow and access within the system 800. In some implementations, only blockchain nodes with a requisite level of security clearance may be able to access, update, or query certain data fields depending on their assigned privacy level. This mechanism, therefore, enables selective exposure of data, thereby enhancing data privacy and minimizing the risk of unauthorized access by ensuring that only appropriate nodes within the platform's ecosystem interact with high-sensitivity data. The use of privacy levels may further support the platform's objectives of compliance and data protection by segmenting access control based on data classification, aligning with privacy regulations and organizational policies.

In the illustrated example, “PL1” and “PL2” may represent two distinct privacy levels, with each level specifying different permissions for data access and handling. For example, “PL1” may denote a high-security classification for sensitive personal data, such as financial information or health records, which can only be accessed by nodes within the governance platform 802 that possess high-security clearance and explicit authorization. Data sets having a privacy level of “PL1” may only be accessible by trusted blockchain nodes with stringent access controls in place, ensuring that this sensitive data remains protected and is only available to individuals or applications that meet the requisite security standards.

Conversely, “PL2” might represent a lower privacy level for data that is less sensitive, such as customer preferences or general interaction data. Data sets having a privacy level of “PL2” may be accessible by a broader set of nodes within the platform, allowing for efficient querying and processing without compromising sensitive information. For instance, nodes involved in analytics or customer service might access “PL2” data for operational tasks, while “PL1” data would remain restricted to minimize privacy risks. This layered approach to privacy levels may allow the system 800 to balance data accessibility with stringent privacy requirements, ensuring compliance and minimizing the exposure of sensitive data. In some implementations, any number of different privacy levels may be employed with any number of different restrictions associated therewith.

Transaction-specific fields 822 may contain details about a data transaction, such as source and destination IDs, a date field, a time field, an access type (AT) field, or a validation ID, among other examples. In the data privacy governance system, transaction-specific fields 822 within the SBCL 818 capture granular details of each data transaction, supporting rigorous tracking and data integrity verification. For example, a source ID field may hold an ID corresponding to the origin of the transaction, such as a specific application server responsible for processing customer data or an internal department, such as HR, that initiates a data update. A destination ID field, on the other hand, might represent the endpoint or recipient of the data transaction, such as a customer relationship management (CRM) system, an authorized third-party application, or an analytics department. By associating each transaction with explicit source and destination identifiers, the system 800 may provide a clear, traceable pathway for each data transaction, enhancing oversight and simplifying audits to ensure that only intended recipients are engaged with particular data sets.

Additionally, the transaction-specific fields 822 may include a date field and a time field, respectively documenting the precise date and time of each transaction to establish a temporal record of data access and usage. These timestamps may enable chronological tracking of interactions with the data, which may be particularly useful in identifying trends in data usage or pinpointing suspicious activity, such as data accessed during unauthorized time frames. The AT field within these transaction fields may detail the type of access granted, with values that clarify the nature and scope of each interaction. For example, an AT value of “F(DS)” could indicate access to the full data set, while “AD” could signify access to an anonymized version of the data derived from the full data set, which masks personally identifiable information (PII) but retains insights necessary for analysis. These access types may allow the system to distinguish between transactions involving direct interaction with sensitive data versus anonymized data, facilitating more precise access control and auditing.

Furthermore, a validation ID (shown as “valid ID.”) field may be included within the transaction-specific fields, providing a unique token or cryptographic signature for each transaction to verify its legitimacy. This validation ID might be generated by an authorized blockchain node within the system 800, confirming that the transaction has met established security checks before it is recorded on the ledger. For instance, a transaction where an HR server with a “PL1” classification requests “AD” access to an anonymized dataset could be validated with a corresponding validation ID, signifying that the access request adheres to the platform's access protocols. By combining the source and destination IDs, date and time fields, AT field, and validation ID, the system 800 may enable a highly detailed, verifiable audit trail that supports compliance, enhances security, and allows for efficient tracking of sensitive data movement. This architecture may facilitate quickly detecting and mitigating unauthorized access, providing a robust foundation for maintaining privacy and regulatory compliance.

Blockchain-specific fields 824 may include elements configured for maintaining the integrity and functionality of the blockchain, such as validation status and blockchain permission fields. As shown, for example, the blockchain-specific fields 824 may include a blockchain permission (BCP) field, a primary blockchain ID (PBC ID) field, and a secondary blockchain ID (SBC ID) field. The BCP field may specify the level of blockchain access and operational permissions granted to different nodes. For example, the BCP field may indicate that a node is permitted only to “read” from the blockchain, restricting it from writing or modifying records, thereby ensuring that only authorized nodes can contribute or alter data in sensitive transactions. The PBC ID may store a unique identifier associated with the PBCL 816, denoting that the record is part of the authoritative chain for data transactions. In instances where the PBCL 816 serves as the central ledger holding comprehensive, high-security data records, the PBC ID may help streamline queries and ensure that the primary ledger remains distinct and easily identifiable within the system 800.

Similarly, the SBC ID field may reference the SBCL 818 associated with a specific subset of data transactions, which may be tailored for particular situations, departments, or user groups. For example, while the PBCL 816 might contain all transactional details for regulatory and audit purposes, the SBCL 818 could hold only anonymized or department-specific data for user-friendly, efficient querying by operational nodes with lower clearance levels. The SBC ID may allow the system 800 to direct requests to the appropriate ledger depending on the data user's requirements and permissions, which may enhance query performance while maintaining compliance with privacy protocols. Collectively, these blockchain-specific fields may contribute to the platform's robust security and access control by governing node permissions, identifying and directing data to the correct ledger, and enabling multi-tiered access that aligns with privacy and data governance policies.

The process of building the blockchain begins when data 826 enters the system through the telemetry service 804. The infrastructure 806 processes this data and creates a block 828, which is added to the primary blockchain ledger 816. As shown, for example, the block 828 may indicate that a full data set (“F(DS)”) having the data ID X was obtained from a client (“CL”) by the telemetry service (“TL”) at 12:32:02 on Oct. 1, 2024. A blockchain update indication 830 may be sent to the data governance platform 802 to notify it of the new block 828.

Similarly, the infrastructure 806 may receive the data 826 from the telemetry service 804 and may create another block 832 based on receiving the data. As shown, the block 832 may indicate that the infrastructure 806 (“IF”) received the full data set from the telemetry service (“TL”) at 12:32:38 on Oct. 1, 2024. The infrastructure 806 may send blockchain update indication 834 to the data governance platform 802 based on generating the block 832. This process ensures that all data movements and accesses are recorded in the blockchain, providing a comprehensive and immutable audit trail.

The system 800 also may handle data event requests and validations. The enterprise access component 810 can initiate a data event request (DER) 836, which may be validated through a data event validation process, resulting in a data event validation 838 being provided to the enterprise access component 810. For example, engineers at an organization may utilize the enterprise access component 810 to securely request access to various data sets needed for data-driven projects, such as training machine learning models or performing data analysis. The data event validation process may ensure that the requesting entity has the necessary permissions and that the data access complies with privacy protocols specified by blockchain-specific fields, such as the BCP field and AT field. For example, the enterprise access component 810 may request access to a subset of the full data set (“F(DS)”) captured by the telemetry service 804 for feature extraction purposes, and the validation process will check whether the requested data is authorized for such use based on privacy level classifications and node permissions. This validation may ensure that engineers can only access data within the authorized boundaries, allowing them to utilize data responsibly while maintaining compliance with data governance policies.

Furthermore, the enterprise access component 810 may allow engineers to utilize anonymized data sets, indicated by an access type (AT) of “AD,” for machine learning model development. For instance, once access to anonymized versions of customer data has been validated, the component enables engineers to retrieve this data without exposing personal identifiers, supporting compliance with data privacy regulations while meeting data needs for model training. This approach may be especially beneficial for creating models that analyze customer trends or perform predictive analytics, as it allows engineers to leverage data that reflects real-world patterns without compromising sensitive information. By controlling access to data sets based on privacy levels and permissions, the enterprise access component 810 provides a secure, compliant environment for machine learning activities, supporting the organization's objectives of both privacy protection and innovation in data-driven projects.

In the illustrated example, an engineer has requested an anonymized data set. As shown, the data web service 808 may receive the data 826 from the infrastructure 806 and may generate a block 840 as a transaction record corresponding to this transaction. As shown in FIG. 8B, the block 840 may show that the data web service (“DWS”) 808 received the full data set at 10:32:06 on Nov. 11, 2024. The data web service 808 may generate an anonymized data set 842 from the full data set 826 and may add a block 844 to the SBCL 818. As shown in FIG. 8B, the block 844 may indicate that the data web service 808 accessed the full data set to generate the anonymized data set 842 at 10:32:54 on Nov. 2, 2024.

As shown in FIG. 8A, the data web service 808 may provide, and the enterprise access component 810 may obtain, the anonymized data set 842. The enterprise access component 810 may add a block 846 to the SBCL 818 based on receiving the anonymized data set 842. As shown in FIG. 8B, the block 846 may indicate that the enterprise access component 810 received the anonymized data set (corresponding to an access type “AD”) at 10:33:01 on Nov. 2, 2024 from the data web service 808. Further data transactions associated with the data set and/or other data sets may result in additional blocks being added to the SBCL 818, which may be copied by the PBCL 816. In various implementations, any number of other data types may be recorded in the transaction records (e.g., blocks) such as, for example, data transaction IDs and/or data transaction durations, among other examples.

In some implementations, a primary blockchain ledger is maintained by the lineage service and secondary blockchain ledgers are distributed to different network nodes. The secondary blockchain ledgers can be copies of the primary blockchain ledger, subsets of the primary blockchain ledger, or may contain different information than the primary blockchain ledger. For example, a secondary blockchain ledger may be used to track data associated with a specific software service, such as conferencing software. This ledger would record all actions performed on data related to that service, including data access, usage, and deletion. This approach provides a detailed audit trail for a specific service, enabling organizations to monitor data handling practices and ensure compliance with relevant regulations.

In another example, a secondary blockchain ledger could be used to track data associated with a specific customer. This ledger would record all actions performed on that customer's data, including access, modification, and deletion. This approach provides a comprehensive audit trail for a specific customer's data, allowing for easy verification of data handling practices.

In yet another example, a secondary blockchain ledger could be used to track data associated with a specific type of data, such as personal data, financial data, or medical data. This approach allows for tailored data governance policies and procedures for each type of data, ensuring that sensitive information is handled with appropriate care and attention.

The use of multiple blockchain ledgers can also facilitate data sharing and collaboration between different organizations. For instance, two organizations might agree to use a shared blockchain ledger to track data exchanged between them. This approach enables both organizations to maintain a verifiable record of data transfers, ensuring transparency and accountability in data sharing practices. By leveraging the inherent security and immutability of blockchain ledgers, organizations can establish a robust framework for data privacy management, fostering trust and confidence among stakeholders.

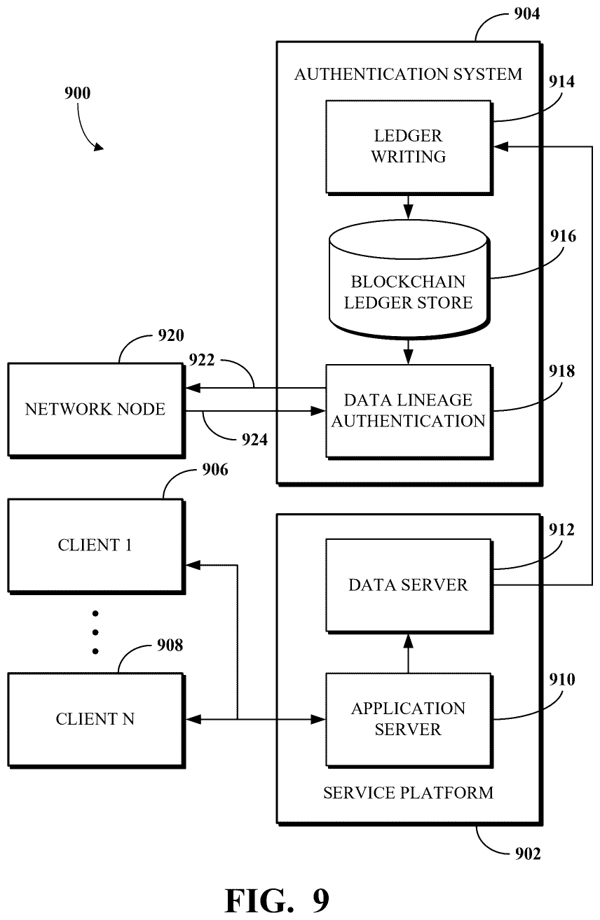

FIG. 9 is a block diagram of an example of a system 900 for data authentication using blockchain ledgers. The system 900 includes a service platform 902 and an authentication system 904. The service platform 902 and/or the authentication system 904 may be, be similar to, include, or be included in the data governance platform 802, the telemetry service 804, the infrastructure 806, the data web service 808, the enterprise access component 810, or the administrative component 812 shown in FIG. 8A; the lineage service 706, the data governance platform 702, the telemetry service 730, the infrastructure 708, the data web service 714, the enterprise access component 720, or the administrative component 722 shown in FIG. 7; the platform server device 602 or the training server 616 shown in FIG. 6; the contact center 500 shown in FIG. 5; the conferencing system 400 shown in FIG. 4; the software platform 300 shown in FIG. 3; or the datacenter 106 shown in FIG. 1.

The service platform 902 may include hardware and/or software configured to enable data transactions with and/or between two or more clients including, as shown, a client 1 906 and a client N 908 in which N is an integer greater than 1. Any one or more of the clients 906-908 may be, be similar to, include, or be included in any device having a client application (e.g., the client application 612 shown in FIG. 6) and/or a blockchain node application (e.g., the blockchain node applications 814A-F shown in FIG. 8A).

The authentication system 904 may include hardware and/or software configured to store records of data transactions facilitated by the service platform 902 within blockchain ledgers and to authenticate the lineage associated with those data transactions based on information associated with respective records within those blockchain ledgers.

The service platform 902 may include an application server 910 and a data server 912. The application server 910 may enable communications among or between the clients 1 906 through N 908, and/or communications between the clients 1 906 through N 908 and the service platform 902 or some other device. The application server 910 may use hardware and/or software for enabling any number of other data transactions such as, for example, data storage operations, data processing operations, data transformation operations, or the like. In some implementations, the application server 910 may, for example, enable functionality of the conferencing system 400 shown in FIG. 4 and/or the contact center 500 shown in FIG. 5.

The data server 912 may obtain transaction data associated with data transactions enabled by the application server 910. For example, the data server 912 may use hardware and/or software to process data received from the application server 910 to generate transaction data. In some cases, the transaction data is incrementally generated during a transaction such that a transaction record as a whole is considered generated upon the processing of the last data at the end of the data transaction. In other cases, the transaction record may be generated after the data transaction ends using data which is temporarily stored for processing following the end of the data transaction. Any number of other approaches for generating transaction records associated with data transactions also are considered to be within the ambit of the present disclosure.

The authentication system 904 includes ledger writing components 914, a blockchain ledger store 916, and data lineage authentication components 918. The ledger writing components 914 receive the transaction record generated by the data server 912 write a record associated with the data transaction within a blockchain ledger stored at the blockchain ledger store 916. In particular, the ledger writing components 914 write data used to reconstruct the transaction record within a new record inserted within the blockchain ledger. The transaction record may include an identifier of the record, an identifier of the blockchain ledger, an identifier of one or more participating clients (e.g., nodes) of the data transaction, a type of the data transaction, timing information associated with the data transaction, or an access type associated with the data involved in the data transaction, among other examples.

The blockchain ledger stores one or more records associated with one or more data transactions. The particular format of the record may vary based on the structure of the blockchain ledgers used with the system 900. For example, the format may be a block-based format in which a new record is written to a block within the blockchain ledger, a table-based format in which a new record is written to a table row or column within the blockchain ledger, or a diagram-based format in which a new record is written to a new entity diagrammatically connected to one or more other entities within the blockchain ledger. The ledger writing components 914 write the record of the data transaction received from the data server 912 within a next data space (e.g., a next block) within the blockchain ledger. The blockchain ledger to which the ledger writing components 914 write the record may be associated with an entity, for example, a customer of a software platform provider.

The blockchain ledger store 916 is a data store, database, or other repository that stores one or more blockchain ledgers, including the blockchain ledger within which the record of the data transaction is written by the ledger writing components 914. The blockchain ledger store 916 may, for example, be implemented using the database server 110 shown in FIG. 1. The blockchain ledgers stored within the blockchain ledger store 916 are distributed a network for access by multiple network nodes, including a network node 920. The network nodes may be associated with the entity with which the blockchain ledger is associated. The network nodes may be authenticated to access some or all of the blockchain ledger and may be client devices or non-client devices. As such, copies of the blockchain ledger into which the ledger writing components 914 wrote the record associated with the data transaction received from the data server 912 may exist across a network. Those copies may be updated to include the record associated with the data transaction such as responsive to the ledger writing components 914 writing the record associated with the data transaction into the distributed transaction record.

The data lineage authentication components 918 authenticate a data transaction lineage associated with a data transaction as a true representation of a subject data transaction based on information stored within a blockchain ledger at the blockchain ledger store 916. Authenticating a data transaction lineage based on the information stored within a blockchain ledger at the blockchain ledger store 916 includes verifying transactional information stored within a record associated with the data transaction within the blockchain ledger to confirm that the record was written when the data transaction was generated. Because each record within the blockchain ledger includes a unique transactional identifier based on a writing thereof, such as based on a time of writing, the data lineage authentication components 918 can determine whether a latest record which includes data usable to reconstruct the data lineage matches the transactional identifier generated for the original writing of the data transaction lineage data into the blockchain ledger. The data lineage authentication components 918 output an indication 922 of the authentication for further processing or display at the network node 920.

In particular, the indication of the authentication indicates that the data transaction record is a true representation of the transaction where a record which includes data usable to reconstruct the transaction record and an identifier written based on the original writing of the transaction record to the blockchain ledger is a latest such record within the blockchain ledger. Similarly, the indication of the authentication indicates that the transaction record is not a true representation of the data transaction where a later record including data usable to reconstruct the transaction record includes an identifier not based on the original writing of the transaction record to the blockchain ledger. The form of the indication output for further processing or display may be a visual indicator, an audio indicator, a text indicator, or the like. For example, the indication may be output over one or more modalities, including but not limited to telephony, conference, messaging, or the like.

The data lineage authentication components 918 perform the authentication based on a request 924 received from the network node 920. The data lineage authentication components 918 output the indication 922 of the authentication to the network node 920 in response to the request 924. The request 924 may, for example, be a request to audit the data trail recorded within the blockchain ledger.

The above flow of operations is described to include writing a record associated with a data transaction within a blockchain ledger. In such a case, each record within a blockchain ledger corresponds to a different data transaction, and records associated with data transactions may continue to be written within the blockchain ledger until the blockchain ledger is full (e.g., as determined based on a maximum number of records defined for the blockchain ledger or due to compute resource limitations).

In some implementations, the status of all network nodes which implement copies of the blockchain ledger may be checked before a transaction record stored within a blockchain ledger may be accessed or modified. For example, where one or more such network nodes are offline or otherwise not discoverable at a given time, the access to or modification of the transaction record may result in different information being recorded across the copies of the blockchain ledger. Accordingly, in such a case, access to the records of the blockchain ledger which correspond to the data transaction may be restricted until all network nodes are determined to be available. The status of the network nodes may be determined by pinging those network nodes and determining whether a response is received therefrom or based on information pushed or pulled from those network nodes.

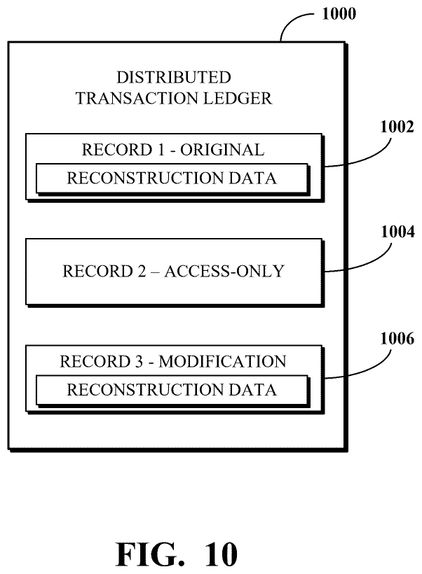

FIG. 10 is a block diagram of an example of an audit trail exposed for a blockchain ledger 1000 which stores records associated with data transactions. An original record 1002 associated with a data transaction is stored within the blockchain ledger 1000 when the transaction record is generated. The original record 1002 includes data usable to reconstruct the transaction record such as for later review at a network node. In some cases, additional records associated with the data transaction may also be stored with the blockchain ledger 1000, such as by linking those additional records to the original record 1002. Examples of additional records which may be stored include access-only records 1004 indicative of a read-only access of records associated with the data transaction, such as for auditing purposes, and modification records 1006 indicative of a change to the data recorded to the initial record of the data transaction.

Access-only records 1004 may be generated and written into the blockchain ledger 1000 in response to an operator device accessing the original record, transmitting an authentication request to authenticate a transaction record within the blockchain ledger 1000, or accessing the blockchain ledger 1000 to perform an audit of transaction records associated with a set of data, a customer, a network node, and/or a service, among other examples. Modification records 1006 may be generated and written into the blockchain ledger 1000 in response to a detected modification to a file of the transaction record, such as where a copy of the transaction record is created or changed. The modification may, for example, be detected based on a diffing operation performed against the new file and the original file from the original record for the transaction record.

The set of records 1002, 1004, and 1006 may form an audit trail. This audit trail including the record 1 1002, the record 2 1004, and the record 3 1006 may be exposed to one or more devices which can access the blockchain ledger 1000. This audit trail can be inspected or evaluated at various times throughout the life of the audit trail (e.g., a period of time during which the audit trail must be maintained) to understand when, how, and by who data transactions occur with respect to the data. For example, the audit trail may remain available during a compliance time period set based on the entity for which the records 1002 through 1006 are generated.

FIG. 11 is a block diagram of an example of a system 1100 with decentralized storage. As shown, the system includes a network node 1102, a network node 1104, a network node 1106, enterprise servers 1108A, 1108B, and decentralized storage 1110. Any one or more of the network nodes 1102, 1104, and 1106 may be, be similar to, include, or be included in the network node 920, the client 1 906, or the client N 908 shown in FIG. 9.

The enterprise servers 1108A-B may be associated with enterprises (e.g., businesses or other entities) that use the system 1100 to communicate with users of network nodes (e.g., the network nodes 1102, 1104, 1106) and/or to process data at or for the network nodes. The enterprise servers 1108A-B may include at least one of a server of a business operating the system 1100, a server of a service provision business, or a server of a business transacting with a user of the network node 1102. The service provision business may provide a service (e.g., a software service, a communication service, an AI service, or a support service, among other examples) via the system 1100.

The decentralized storage 1110 distributes data across multiple nodes of a decentralized computer network. As a result, the data in the decentralized storage 1110 may be accessible if one of the nodes is unavailable or not working, and the data in the decentralized storage may be difficult to modify, as modification might require notifying each of the multiple nodes that stores the modified data of the change. The decentralized storage 1110 may be implemented using a decentralized storage solution such as, for example, a blockchain storage solution. As used herein, the phrase “decentralized storage” encompasses, among other things, a storage system in which data are distributed across multiple nodes, rather than being concentrated in a single location. As a result, there might be no single point of failure, and the storage system may be more resilient to attack or disruption.

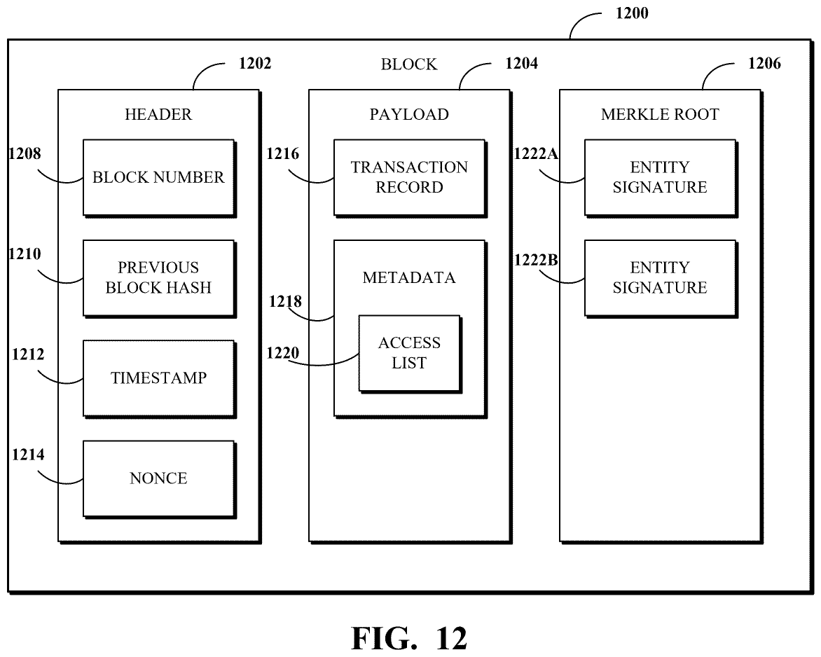

As shown, the decentralized storage 1110 includes a blockchain 1112, which includes multiple blocks 1114A-D. The blockchain 1112 may be a private blockchain that is permissioned, meaning that only authorized participants (e.g., the enterprise servers 1108A, 1108B) may participate in a consensus process for adding or removing the blocks 1114A-D. Each block 1114A-D stores a transaction record associated with a data transaction, which may include metadata of the data transaction or other information for including the block 1114 (where “block 1114” refers to one of the blocks 1114A-D) in the blockchain 1112. To ensure security of the blockchain 1112, each block 1114A-D includes a Merkle root, which is a mathematical function of other data in the block. The Merkle root may be digitally signed (e.g., using a mathematical function, for example, the RSA (Rivest-Shamir-Adleman) algorithm or the DSA (digital signature algorithm)) by one or more entities (e.g., one or more of the business servers 1108A-B) to ensure that the block is not modified without the consent of the one or more entities. Each block 1114A-D also includes a hash (e.g., a cryptographic hash) of a previous block in the blockchain 1112. Each block 1114A-D may also include a pointer to at least one of the previous block or a next block in the blockchain 1112. An example of the block 1114A-D of the blockchain 1112 is described in conjunction with FIG. 12.

According to some implementations, a data transaction may be conducted, via the network node 1104, between the network node 1102 and the network node 1106. The data transaction may be associated with one or more services associated with the enterprise servers 1108A, 1108B. For example, the data transaction may be associated with a service provided by a business of the enterprise server 1108A and may be handled by agents working for a business of the enterprise server 1108B. The data transaction may be recorded by the network node 1104. After the data transaction is completed, a transaction record may be written to a block 1114A of the blockchain 1112. The transaction record may identify network nodes associated with the data transaction (e.g., network nodes 1102, 1104, and 1106), enterprise servers associated with the data transaction (e.g., the enterprise servers 1108A-B) associated with the engagement, and, in some cases, other information about the data transaction, such as a transaction start time, a transaction duration, a hold time duration, a transaction end time, an identifier of a user participating in the data transaction, an identifier of a type of data transaction, an identifier of a type of data access associated with the data transaction, or a summary of the data transaction, among other examples. The block 1114A of the blockchain 1112 including the data transaction may be made accessible to the network nodes 1102, 1104, and 1106 associated with the data transaction and/or to one or more devices accessing the block 1114A via one of the enterprise servers 1108A-B associated with the data transaction.

As illustrated, the enterprise servers 1108A-B are distinct. In some cases, the enterprise servers 1108A-B may be integrated. Furthermore, while two enterprise servers 1108A-B are illustrated, in some cases, there may be one, two, three or another number of enterprise servers 1108A-B. Similarly, there may be any number of network nodes. Furthermore, while the blockchain 1112 is illustrated as including four blocks 1114A-D by example, the blockchain 1112 may include other numbers of blocks.

FIG. 12 is a block diagram of an example of a block 1200 of a blockchain (e.g., the blockchain 1112). The block 1200 may correspond to one of the blocks 1114A-D. As shown, the block 1200 includes a header 1202, a payload 1204, and a Merkle root 1206.

The header 1202 includes a block number 1208, a previous block hash 1210, a timestamp 1212, and a nonce 1214. The block number 1208 identifies the block. In some implementations, the block number 1208 may be replaced with a block identifier that is not a number. The previous block hash 1210 may correspond to a hash function (e.g., a cryptographic hash function) of a previous block in the blockchain (or a hash of zero if the block 1200 is the first block). As used herein, a hash function is a function that maps a data item of arbitrary size to a data item of fixed size. The output of a hash function is called a hash value, hash code, digest, or simply a hash. For example, a hash function may be hash (x)=int (x) mod 1000. This hash function returns an integer between 0 and 999 regardless of the value of x. The timestamp 1212 may correspond to a time when the block 1200 was last modified. The nonce 1214 may be a unique, arbitrary, or pseudo-arbitrary number that may only be used once. The nonce 1214 may be used to compute the Merkle root 1206, as described below.

The payload 1204 includes a transaction record 1216 and metadata 1218. The transaction record 1216 may include any number of different types of information associated with a data transaction. The metadata 1218 may include any metadata associated with the data transaction or the set of data involved in the transaction. As illustrated, the metadata 1218 may include an access list 1220. In some cases, the metadata 1218 may include at least one of identifiers of one or more network nodes (e.g., servers, clients, user devices, etc.) associated with the data transaction, identifiers of one or more user accounts associated with the data transaction, identifiers one or more businesses (or other entities) associated with the data transaction, identifiers of one or more enterprise servers (e.g., a subset of the enterprise servers 1108A-B) associated with the data transaction, a transaction duration, a hold time duration, a transaction start time, a transaction end time, a data transaction type, a data access type, or a summary of the data transaction, among other examples.

The access list 1220 in the metadata 1218 may include a list (or other data structure) of accounts, devices, clients, nodes, or servers that have read access (and, in some cases, also write access) to the block 1200. For example, the access list 1220 may identify at least one user account, user device, client, network node, enterprise server, or business entity that is granted read access to the block 1200. For example, users and businesses associated with the data transaction may be granted read access to the block 1200. In some cases, the data involved with the data transaction may be personal data associated with a user of a service and the access list 1220 may grant access to the user and/or one or more administrators only. Any number of different types of data access schemes may be employed in accordance with various implementations.

The Merkle root 1206 is a single hash value that is computed based on all of the data in the header 1202 and the payload 1204. Verification that the header 1202 and the payload 1204 are valid and have not been impermissibly tampered with may be done based on the Merkle root 1206. As illustrated, the Merkle root 1206 includes entity signatures 1222A-B. The entity signatures 1222A-B indicate that the associated entities (e.g., network nodes, servers, etc.) confirm the validity of the header 1202 and the payload 1204 of the block 1200. The entity signatures 1222A-B ensure that the header 1202 and the payload 1204 are not modified without the consent of the entities providing the entity signatures 1222A-B.

Some implementations relate to the use of digital signatures (e.g., the entity signatures 1222A-B). Various digital signature algorithms may be used with the disclosed technology. In some examples, RSA digital signatures are used. RSA digital signatures may be implemented using a public key of a machine (e.g., the network node 1106 or an enterprise server 1108A-B) called e, a private key of the machine called d, and a nonce (e.g., the nonce) called n. The public key e is known to the public, while the private key d is known to the associated machine and not to other machines. For a value to be signed (e.g., the Merkle root) called m, the following functions are defined for each machine:
f(m)=m^{e} mod n is the encryption function, which is public.
g(m)=m^{d} mod n is the decryption function, which is private.

The functions f and g are defined such that f(g(m))=g(f(m))=m. To sign m, a machine computes s=g(m), which is computed using the private key d and the nonce n. Other machines may verify the signature by computing f(s), which should be equal to m and is computed using the public key e and the nonce n. A machine different from the signing machine does not know the function g and, therefore, cannot compute s=g(m).

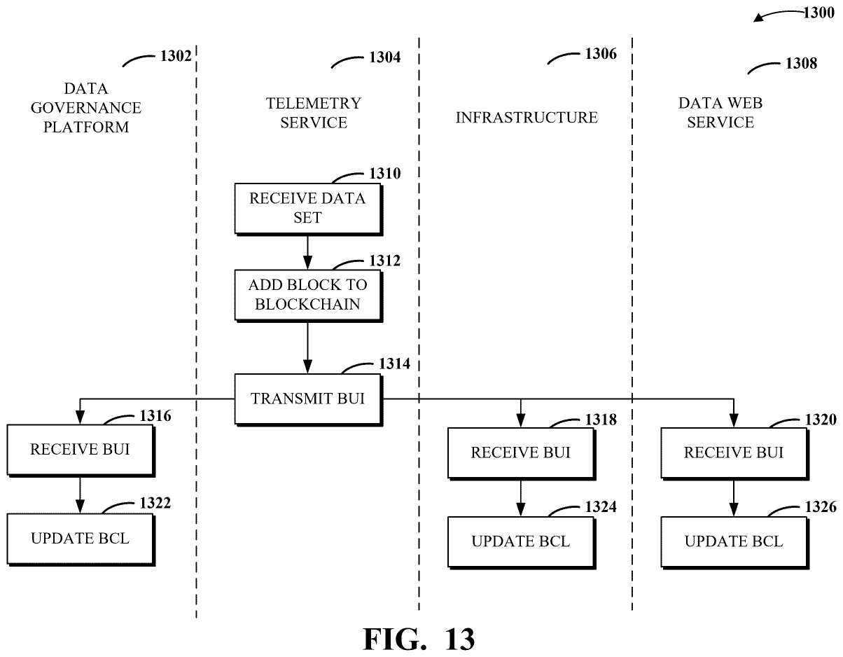

FIG. 13 illustrates a schematic block diagram of an example 1300 associated with blockchain-verified data tracking. The example 1300 depicts a data governance platform 1302, a telemetry service 1304, an infrastructure 1306, and a data web service 1308. These components work together to implement a system for managing and tracking personal data using blockchain technology. Any one or more of the data governance platform 1302, the telemetry service 1304, the infrastructure 1306, and the data web service 1308 may be a network node (or a blockchain node) as described herein and may be, be similar to, include, or be included in the system 1100 (or one or more corresponding components thereof) shown in FIG. 11, the system 900 (or one or more corresponding components thereof) shown in FIG. 9, the example 800 (or one or more corresponding aspects thereof) shown in FIGS. 8A and 8B, the system 700 (or one or more corresponding components thereof), the AI system 600 shown in FIG. 6 (or one or more corresponding components thereof), the contact center 500 (or one or more corresponding components thereof) shown in FIG. 5, the conferencing system 400 (or one or more corresponding components thereof) shown in FIG. 4, the software platform 300 (or one or more corresponding components thereof) shown in FIG. 3, the computing device 200 (or one or more corresponding components thereof) shown in FIG. 2, or the system 100 (or one or more corresponding components thereof) shown in FIG. 1.

The process begins with operation 1310, where the telemetry service 1304 receives a data set. The data set may contain personal information that requires careful handling and tracking. For example, the data set could include customer information collected during a video conference or contact center interaction. The telemetry service 1304 may serve as an initial point of contact for incoming data, ensuring that all data transactions are properly logged and tracked from the moment they enter the system.

Following the receipt of the data set, the telemetry service 1304 performs operation 1312, which involves adding a block to a blockchain. Adding a block to a blockchain may also be referred to as updating a block chain ledger (shown as “BCL”). This operation is configured for maintaining an immutable record of all data transactions within the system. The block added to the blockchain may contain metadata about the received data set, such as its origin, timestamp, and a unique identifier. For instance, if the data set includes personal information from a new customer sign-up, the block might record the time of sign-up, the source of the data (e.g., web form, mobile app), and a hash of the data contents.

Once the block is added to the blockchain, the telemetry service 1304 executes operation 1314, transmitting a BUI. The BUI may be sent to multiple nodes in the network, including the data governance platform 1302, to maintain consistency across the distributed ledger. The data governance platform 1302 then performs operation 1316, receiving the BUI. The data governance platform 1302 may use this information to update its own copy of the BCL, ensuring that it has the latest record of all data movements and accesses.

The infrastructure 1306 executes operation 1318, also receiving the BUI. This allows the infrastructure component to stay synchronized with the latest blockchain updates. The infrastructure 1306 may use this information to manage data storage, access controls, or other system-wide functions based on the latest blockchain state. The infrastructure 1306 then performs operation 1324, updating its copy of the BCL. The BCL may be a secondary BCL (SBCL), containing a subset of information found in a primary BCL (PBCL), with certain sensitive fields omitted. In some implementations, the PBCL may be maintained only at certain nodes such as the data governance platform 1302. For example, if the original data set included detailed personal information, the SBCL might only record that a transaction occurred, without storing the specific details of the personal data.

Meanwhile, the data web service 1308 executes operation 1320, receiving the BUI. This ensures that the data web service, which may handle data processing or provide data access to other parts of the system, is aware of the latest data transactions. The data web service 1308 can use this information to update its internal records or adjust its data handling processes accordingly. The data web service 1308 then performs operation 1326, updating its own copy of the BCL. This operation 1326 maintains consistency across different components of the system, ensuring that all nodes have access to the appropriate level of information based on their role and permissions. For instance, if the data web service 1308 is responsible for providing anonymized data for analytics purposes, it might update its BCL to reflect the latest data transactions while omitting any personally identifiable information.

The data governance platform 1302 executes operation 1322, updating its copy of the BCL. This copy may be, for example, a PBCL. This operation 1322 may ensure that the authoritative record of all data transactions is kept up-to-date. The PBCL may contain more detailed information than the SBCLs, serving as the “source of truth” for the entire system. For example, while an SBCL might record that a data access event occurred, the PBCL could include additional details such as the specific user who accessed the data, the exact time of access, and the type of data that was accessed.

Some implementations of a multi-ledger approach, with a PBCL and multiple SBCLs, may offer several advantages. For example, some implementations may allow for fine-grained access control, where different components or users of the system can be granted access to different levels of detail in the blockchain records. This may be particularly useful for maintaining data privacy and compliance with regulations such as GDPR, which require careful management of personal data. Some implementations could include additional layers of blockchain ledgers, each tailored to specific use cases or data sensitivity levels. For instance, there could be separate SBCLs for financial data, health data, and general customer information, each with its own set of access controls and data field masking rules. Some implementations could involve the use of smart contracts within the blockchain system. These smart contracts could automatically execute certain actions based on predefined conditions. For example, a smart contract could be set up to automatically anonymize or delete certain types of personal data after a specified retention period, ensuring compliance with data protection regulations.

Some implementations may include more sophisticated data lineage tracking. By linking blocks across different ledgers, it may be possible to trace the entire lifecycle of a piece of data, from its initial collection by the telemetry service, through various processing steps in the data web service, to its eventual archival or deletion. This comprehensive tracking may facilitate auditing purposes and responding to data subject access requests.

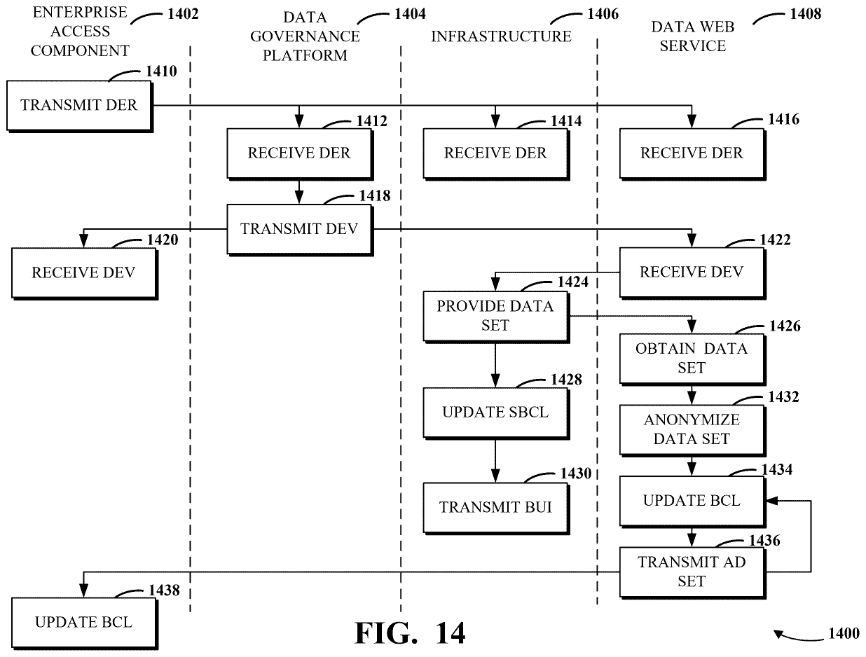

FIG. 14 is a schematic block diagram showing another example 1400 associated with blockchain-verified data tracking. As shown, the example 1400 includes an enterprise access component 1402, a data governance platform 1404, an infrastructure 1406 and a data web service 1408. Any one or more of the enterprise access component 1402, the data governance platform 1404, the infrastructure 1406 and the data web service 1408 may be a network node (or a blockchain node) as described herein and may be, be similar to, include, or be included in the system 1100 (or one or more corresponding components thereof) shown in FIG. 11, the system 900 (or one or more corresponding components thereof) shown in FIG. 9, the example 800 (or one or more corresponding aspects thereof) shown in FIGS. 8A and 8B, the system 700 (or one or more corresponding components thereof), the AI system 600 shown in FIG. 6 (or one or more corresponding aspects thereof), the contact center 500 (or one or more corresponding components thereof) shown in FIG. 5, the conferencing system 400 (or one or more corresponding components thereof) shown in FIG. 4, the software platform 300 (or one or more corresponding components thereof) shown in FIG. 3, the computing device 200 (or one or more corresponding components thereof) shown in FIG. 2, or the system 100 (or one or more corresponding components thereof) shown in FIG. 1.

The process begins with operation 1410, where the enterprise access component 1402 transmits a DER. This operation 1410 may be initiated when an authorized user, such as an engineer or data analyst, needs to access or process personal data for a specific purpose. For example, a data scientist might request access to anonymized customer data to train a machine learning model for improving service recommendations. Following the transmission of the DER, the data governance platform 1404 performs operation 1412, receiving the DER. The data governance platform 1404 may function as a gatekeeper, ensuring that only authorized and necessary data access occurs within the system.

The DER is then forwarded to the infrastructure 1406, which executes operation 1414, receiving the DER. The infrastructure 1406 may represent the core data storage and processing systems of the organization. Upon receiving the DER, the infrastructure 1406 may perform initial checks to ensure the request is valid and can be processed. The data web service 1408 performs operation 1416, also receiving the DER. The data web service 1408 may serve as an interface between the data storage systems and various data processing applications. Its involvement in the process ensures that the data access request is properly routed and can be fulfilled using the appropriate data services.

In some implementations, as indicated above, the DER may be transmitted to multiple nodes as part of the blockchain validation process for a data transaction. This approach may enhance the security and reliability of the system by ensuring that multiple nodes independently verify and validate the data event request. By distributing the DER to various nodes, the system may create a consensus mechanism where multiple parties must agree on the validity of the request before it is processed. This distributed validation process may help prevent unauthorized access attempts, detect potential security breaches, and maintain the integrity of the blockchain. Additionally, transmitting the DER to multiple nodes may provide redundancy in the system, ensuring that the request is processed even if one or more nodes are unavailable or compromised. This multi-node validation approach may also support the implementation of more complex access control policies, where different nodes may have varying levels of authority or specialized roles in the validation process.

After processing the DER, the data governance platform 1404 executes operation 1418, transmitting a DEV message. This validation step facilitates maintaining data privacy and security. The DEV message may be based on a blockchain permission value stored in a blockchain associated with the requested data set, as described in the claims. For instance, if the earlier example of the data scientist requesting anonymized customer data is considered, the DEV message might confirm that the scientist has the necessary permissions to access anonymized data but not raw personal data.

The enterprise access component 1402 then performs operation 1420, receiving the DEV message. This confirmation allows the enterprise access component to proceed with the data access request, knowing that it has been validated against the organization's data governance policies. The data web service 1408 executes operation 1422, receiving the DEV message. This ensures that the data web service is aware of the validated request and can proceed with retrieving or processing the requested data in accordance with the permissions granted.

The infrastructure 1406 performs operation 1424, providing the requested data set. This operation may involve retrieving the data from secure storage, applying any necessary transformations or anonymization procedures, and preparing it for transmission. For example, if the request was for anonymized customer data, the infrastructure might apply data masking techniques to remove personally identifiable information before providing the data set. The data web service 1408 then executes operation 1426, obtaining the data set from the infrastructure. This step represents the actual transfer of the requested data to the service that will make it available for use. The infrastructure 1406 performs operation 1428, updating its copy of the SBCL based on providing the data set to the data web service 1408. The infrastructure 1406 may perform operation 1430, transmitting a BUI based on updating the SBCL in operation 1428.

In some cases, additional data protection measures may be required. The data web service 1408 performs operation 1432, anonymizing the data set. This step might be taken even if the data was already partially anonymized by the infrastructure, to ensure an extra layer of privacy protection. For instance, the data web service might apply advanced anonymization techniques such as differential privacy to further protect individual user data while maintaining the overall utility of the dataset for analysis.

Following the anonymization process, the data web service 1408 executes operation 1434, updating its copy of the BCL (which may be, in some implementations, an SBCL). This operation ensures that the blockchain maintains an accurate record of all data access and transformation events. The update to the BCL may include metadata about the anonymization process, such as the techniques used and the level of anonymity achieved, without including any of the actual sensitive data. The data web service 1408 performs operation 1436, transmitting the anonymized data set. This makes the properly processed and protected data available for use by the authorized requester. The enterprise access component 1402 executes operation 1438, updating its copy of the BCL (which may, in some implementations, be a PBCL). The PBCL update might include more detailed information about the entire data access event, from the initial request to the final delivery of the anonymized data set.

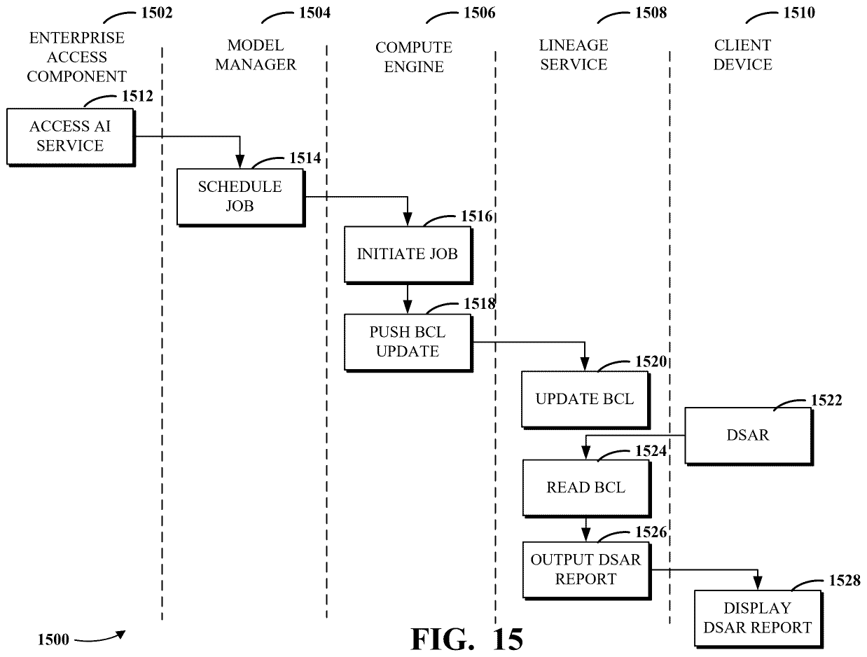

FIG. 15 is a schematic block diagram showing another example 1500 associated with blockchain-verified data tracking. As shown, the example 1500 includes an enterprise access component 1502, a model manager 1504, a compute engine 1506, a lineage service 1508, and a client device 1510. Any one or more of the enterprise access component 1502, the model manager 1504, the compute engine 1506, the lineage service 1508, and the client device 1510 may be a network node (or a blockchain node) as described herein and may be, be similar to, include, or be included in the system 1100 (or one or more corresponding components thereof) shown in FIG. 11, the system 900 (or one or more corresponding components thereof) shown in FIG. 9, the example 800 (or one or more corresponding aspects thereof) shown in FIGS. 8A and 8B, the system 700 (or one or more corresponding components thereof), the AI system 600 shown in FIG. 6 (or one or more corresponding aspects thereof), the contact center 500 (or one or more corresponding components thereof) shown in FIG. 5, the conferencing system 400 (or one or more corresponding components thereof) shown in FIG. 4, the software platform 300 (or one or more corresponding components thereof) shown in FIG. 3, the computing device 200 (or one or more corresponding components thereof) shown in FIG. 2, or the system 100 (or one or more corresponding components thereof) shown in FIG. 1.

The process begins with operation 1512, where the enterprise access component 1502 accesses an AI service. The operation 1512 may be initiated when an authorized user, such as a data scientist or machine learning engineer, needs to access AI services for data analysis or model training purposes. For example, a data scientist might request access to an AI service to develop a new recommendation algorithm based on customer interaction data. Following the AI service access, the model manager 1504 performs operation 1514, scheduling a job. The operation 1514 ensures that AI tasks are properly queued and resources are allocated efficiently. The model manager 1504 may consider factors such as task priority, resource availability, and data dependencies when scheduling jobs. For instance, if multiple data scientists request access to AI services simultaneously, the model manager 1504 might prioritize tasks based on business impact or deadline urgency.

The compute engine 1506 then executes operation 1516, initiating the scheduled job. The operation 1516 involves setting up the necessary computing resources and preparing the environment for the AI task. For example, if the scheduled job involves training a large language model, the compute engine 1506 might allocate GPU clusters and load the required datasets into memory. As the job progresses, the compute engine 1506 performs operation 1518, pushing a BCL update, ensuring that all data access and processing activities are recorded in the BCL, maintaining a transparent and immutable audit trail. The BCL update might include metadata such as the type of AI service accessed, the datasets used, and the duration of the processing task.

The lineage service 1508 executes operation 1520, updating the BCL based on the push from the compute engine 1506. The operation 1520 involves adding a new block to the BCL, which contains the details of the AI service usage and data processing activities. For instance, if the AI service accessed customer purchase history data to train a recommendation model, the lineage service 1508 would record this data access event in the BCL, including timestamps and user identifiers. After the job completion, the lineage service 1508 performs operation 1522, updating the BCL to reflect the job's outcome. The operation 1522 ensures that the BCL maintains a complete record of the entire AI service usage lifecycle, from initial access request to final results. The update might include information such as the success status of the job, any data transformations applied, and summary statistics of the processed data.

The lineage service 1508 executes operation 1524, reading the BCL. The operation 1524 allows the system to retrieve and verify the recorded information about data access and AI service usage. For example, if an auditor needs to review the history of AI model training activities, they could use this operation to access a comprehensive, tamper-proof record of all relevant events. Following the BCL reading, the lineage service 1508 performs operation 1526, outputting a DSAR report. The operation 1526 may enable compliance with data privacy regulations by providing individuals with transparency about how their personal data is being used. The DSAR report might include details such as which AI models have processed an individual's data, when these processing events occurred, and for what purposes the data was used. The client device 1510 executes operation 1528, displaying the DSAR report, thereby making the information accessible to the relevant stakeholders, such as data subjects, privacy officers, or regulatory authorities. For instance, a customer might use a secure portal on their device to view a report detailing how their personal data has been used in AI services, including any anonymization techniques applied and the purposes of data processing.

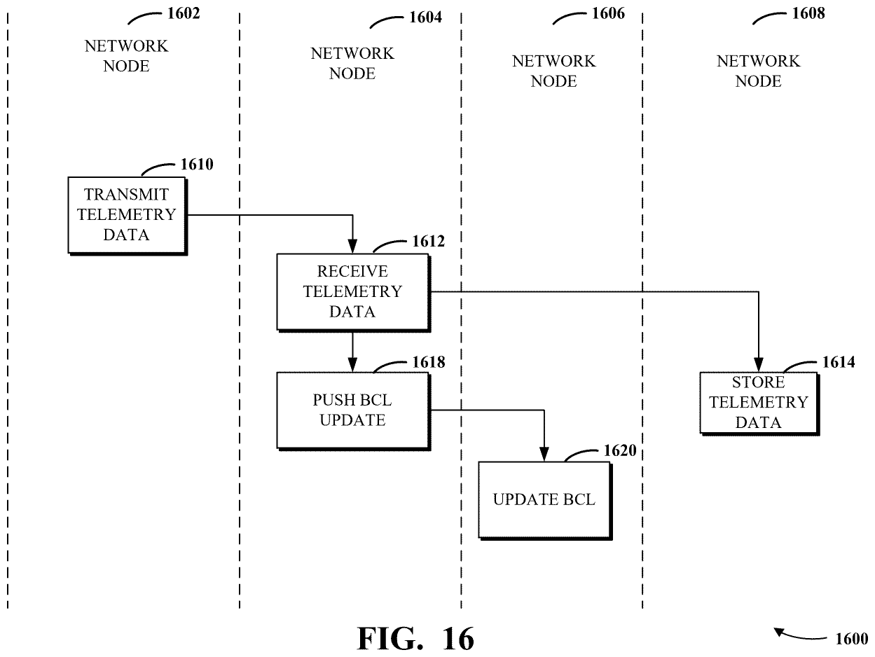

FIG. 16 is a schematic block diagram showing another 1600 example associated with blockchain-verified data tracking. As shown, the example 1600 includes a network node 1602, a network node 1604, a network node 1606, and a network node 1608. Any one or more of the network nodes 1602, 1604, 1606, and 1608 may be a blockchain node as described herein and may be, be similar to, include, or be included in the system 1100 (or one or more corresponding components thereof) shown in FIG. 11, the system 900 (or one or more corresponding components thereof) shown in FIG. 9, the example 800 (or one or more corresponding aspects thereof) shown in FIGS. 8A and 8B, the system 700 (or one or more corresponding components thereof), the AI system 600 shown in FIG. 6 (or one or more corresponding aspects thereof), the contact center 500 (or one or more corresponding components thereof) shown in FIG. 5, the conferencing system 400 (or one or more corresponding components thereof) shown in FIG. 4, the software platform 300 (or one or more corresponding components thereof) shown in FIG. 3, the computing device 200 (or one or more corresponding components thereof) shown in FIG. 2, or the system 100 (or one or more corresponding components thereof) shown in FIG. 1.

The process begins with operation 1610, where network node 1602 transmits telemetry data. Telemetry data refers to information collected from remote or inaccessible points and transmitted to receiving equipment for monitoring. In the context of this disclosure, telemetry data may include various types of information related to data transactions, user activities, or system operations. For example, network node 1602 might transmit telemetry data about user interactions with a software application, including details such as login times, feature usage, or data access patterns. Following the transmission of telemetry data, network node 1604 performs operation 1612, receiving the telemetry data. The operation 1612 may ensure that the telemetry data is captured and ready for further processing within the system. For instance, if network node 1602 transmitted data about user logins to a cloud-based service, network node 1604 would receive and store this information, preparing it for analysis or blockchain recording.

The network node 1608 performs operation 1614, storing the telemetry data. The operation 1614 may facilitate maintaining a comprehensive record of all telemetry data, which can be used for various purposes such as auditing, analysis, or compliance reporting. For example, the stored telemetry data might include aggregated information about user activities, system performance metrics, or data access patterns, all of which could be valuable for improving system security, user experience, or operational efficiency.

Network node 1604 executes operation 1618, pushing a BCL update. The operation 1618 may facilitate maintaining an up-to-date and accurate record of all telemetry data within the blockchain system. The BCL update may include details such as the type of telemetry data received, timestamps, and any relevant metadata. For example, if the received telemetry data pertained to a user accessing sensitive information, the BCL update might include the time of access, the user's identifier, and the type of information accessed, all while maintaining appropriate privacy measures. Network node 1606 performs operation 1620, updating the BCL based on the push from network node 1604. The operation 1620 may ensure that the BCL is consistently updated across multiple nodes, maintaining the integrity and reliability of the data tracking system. For instance, when network node 1606 receives the BCL update about the user accessing sensitive information, it would add this information to its copy of the BCL, potentially including additional details such as the node's own timestamp or validation information.

The example 1600 demonstrates a distributed approach to handling telemetry data, leveraging blockchain technology to ensure data integrity and traceability. By involving multiple network nodes in the process of transmitting, receiving, updating, and storing telemetry data, the system creates a robust and tamper-resistant record of all data-related activities. This approach may offer several advantages in the context of data privacy and governance. For instance, the blockchain-based ledger provides an immutable audit trail of all telemetry data transactions, which can be crucial for demonstrating compliance with data protection regulations. The distributed nature of the system also enhances security, as the data and its transaction history are not stored in a single, vulnerable location but are instead spread across multiple nodes. Moreover, the system's design may allow for flexible implementation of data privacy measures. For example, the ledger updates pushed in operation 1614 and recorded in operation 1618 could include privacy-preserving techniques such as data anonymization or encryption. This would allow the system to track data movements and usage patterns without exposing sensitive personal information, striking a balance between data utility and privacy protection.

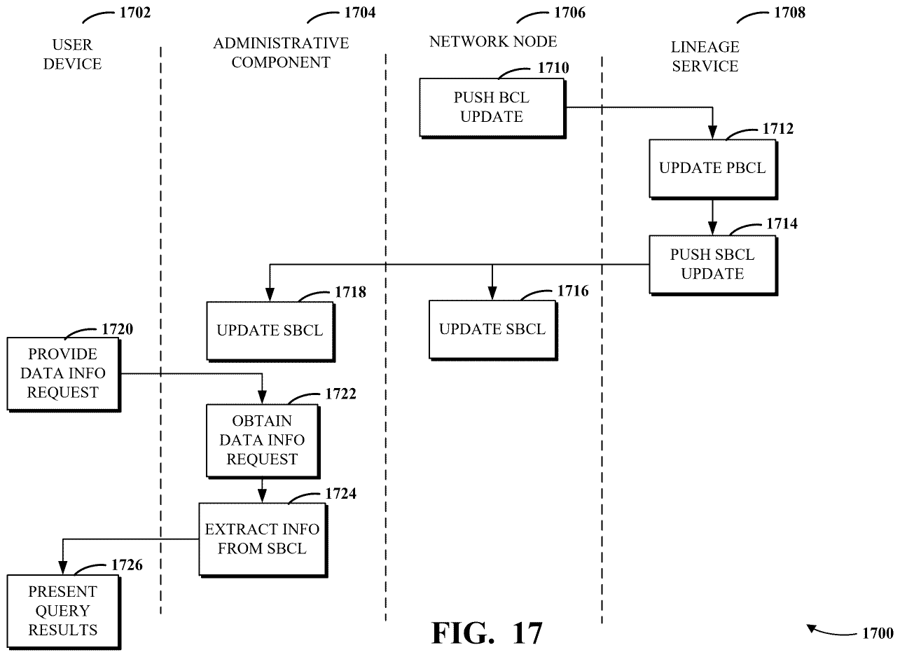

FIG. 17 is a schematic block diagram showing another example 1700 associated with blockchain-verified data tracking. As shown, the example 1700 includes a user device 1702, an administrative component 1704, a network node 1706, and a lineage service 1708. Any one or more of the user device 1702, the administrative component 1704, the network node 1706, and the lineage service 1708 may be a network node (or a blockchain node) as described herein and may be, be similar to, include, or be included in the system 1100 (or one or more corresponding components thereof) shown in FIG. 11, the system 900 (or one or more corresponding components thereof) shown in FIG. 9, the example 800 (or one or more corresponding aspects thereof) shown in FIGS. 8A and 8B, the system 700 (or one or more corresponding components thereof), the AI system 600 shown in FIG. 6 (or one or more corresponding aspects thereof), the contact center 500 (or one or more corresponding components thereof) shown in FIG. 5, the conferencing system 400 (or one or more corresponding components thereof) shown in FIG. 4, the software platform 300 (or one or more corresponding components thereof) shown in FIG. 3, the computing device 200 (or one or more corresponding components thereof) shown in FIG. 2, or the system 100 (or one or more corresponding components thereof) shown in FIG. 1.

As shown in FIG. 17, the network node 1706 performs operation 1710, pushing a BCL update. Pushing a BCL update (whether the BCL is a PBCL, an SBCL, or any other type of BCL) may refer to transmitting a BUI and/or transmitting an indication associated with a transaction (e.g., transmitting a transaction record). A BUI may include a copy of an updated blockchain, a copy of the new block, and/or information associated with the new block, among other examples. The network node 1706 may push the BCL update based on adding a block to a BCL (e.g., associated with a transaction). In some implementations, the network node 1706 may push the BCL update to the lineage service 1708 and/or one or more other network nodes. For instance, when an engineer requests access to a data set including a user's personal data, a new block might be added to the BCL recording details such as the time of the request, the type of information requested, and a unique identifier for the requesting engineer. The lineage service 1708 executes operation 1712, updating a PBCL based on the push from the network node 1706. Based on updating the PBCL, the lineage service 1708 may push an SBCL update in an operation 1714. The SBCL update may prompt the network node 1706 and the administrative component 1704 to update local copies of the SBCL, as shown in operations 1716 and 1718. The operations 1716 and 1718 may involve adding a new block to the SBCL.

In operation 1720, a user device 1702 provides a data information request. The operation 1720 may be initiated when a user wants to know what personal data is being stored or processed by the system. For example, a customer might use their smartphone to send a request asking for details about their account information, transaction history, or any other personal data held by the organization.

The administrative component 1704 performs operation 1722, obtaining the data information request. The operation 1722 may ensure that all data-related inquiries are centrally logged and can be properly evaluated. The administrative component 1704 may function as a gatekeeper, ensuring that only authorized requests are processed. For instance, when receiving a request from a user asking about their personal data, the administrative component 1704 might first verify the user's identity and access rights before proceeding. The operation 1722 may involve processing the received request and preparing it for further action. For example, if a user has requested information about their recent account activities, the administrative component 1704 might format this request into a standardized query that can be understood and processed by other components of the system.

The administrative component 1704 executes operation 1724, extracting information from the SBCL. The operation 1724 may allow the system to retrieve and verify the recorded information about data requests and usage. For instance, when preparing to respond to the user's request for account activity information, the administrative component 1704 might read through the SBCL to compile a comprehensive history of all data accesses and modifications related to that user's account. The operation 1724 may involve otherwise processing the SBCL data to extract the specific information relevant to the user's request. For example, if a user has asked for information about their personal data usage over the past year, the administrative component 1704 might extract all SBCL entries related to that user's data from the past 12 months, compiling them into a format that can be easily understood and presented to the user.

The user device 1702 performs operation 1726, presenting query results. The operation 1726 may involve receiving a formatted set of extracted information (e.g., in the form of a user-friendly report) and delivering it to the requesting user (e.g., by causing a display device associated with the user device 1702 to display the extracted information). For instance, in response to the request for account activity information, the administrative component 1704 might generate a report detailing all instances of data access, modification, or processing related to the user's account over the specified time period. This report could be presented through a secure web portal, sent via encrypted email, or made available through another secure channel, ensuring that the user device 1702 receives a comprehensive and understandable overview of how the personal data has been handled.

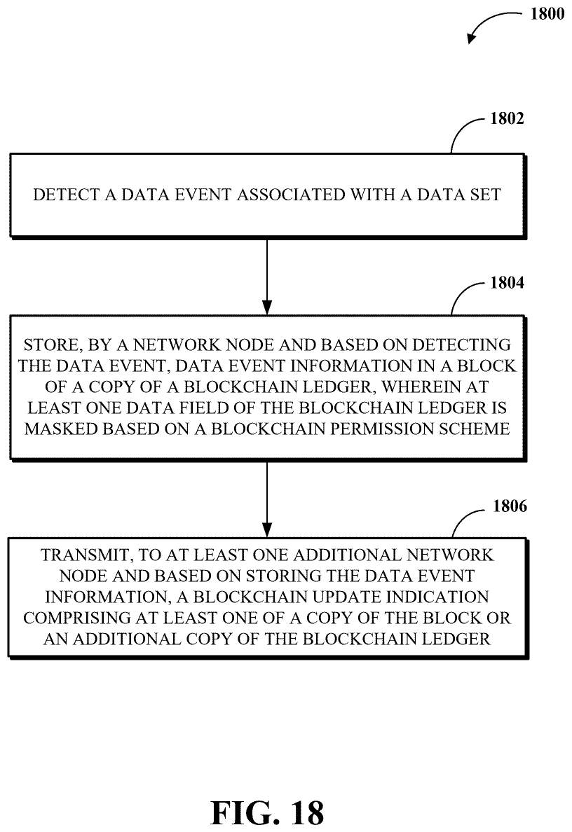

To further describe some implementations in greater detail, reference is next made to examples of techniques which may be performed by or using a system for blockchain-verified data tracking. FIG. 18 is a flowchart of an example of a technique 1800 for blockchain-verified data tracking. The technique 1800 can be executed using computing devices, such as the systems, hardware, and software described with respect to FIGS. 1-17. The technique 1800 can be performed, for example, by executing a machine-readable program or other computer-executable instructions, such as routines, instructions, programs, or other code. The steps, or operations, of the technique 1800, or another technique, method, process, or algorithm described in connection with the implementations disclosed herein can be implemented directly in hardware, firmware, software executed by hardware, circuitry, or a combination thereof.

For simplicity of explanation, the technique 1800 is depicted and described herein as a series of steps or operations. However, the steps or operations of the technique 1800 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The step 1802 includes detecting a data transaction associated with a data set. In some implementations, the data transaction comprises a data movement transaction, a data access transaction, a data deletion transaction, a data modification transaction, or a data usage transaction, among other examples.

The step 1804 includes storing, by a network node and based on detecting the data transaction, data transaction information in a block of a copy of a blockchain ledger, wherein at least one data field of the blockchain ledger is masked based on a blockchain permission scheme. The step 1806 includes transmitting, to at least one additional network node and based on storing the data transaction information, a blockchain update indication comprising at least one of a copy of the block or an additional copy of the blockchain ledger. The blockchain ledger may include a set of data-specific data fields, a set of transaction-specific data fields, or a set of blockchain-specific data fields, among other examples. In some implementations, the blockchain ledger may correspond to the data set, a service, an application, or a function associated with at least one of a service or an application.

In some implementations, the technique 1800 may include determining that the data set comprises personal data, and storing the data transaction information may include storing the data transaction information based on determining that the data set comprises personal data. In some implementations, storing the data transaction information may include storing one or more values in one or more data fields of the blockchain ledger. The one or more data fields may include the at least one data field, and the at least one data field may be indicative of at least one of a data set ID, a privacy level corresponding to the data set, a source ID indicative of a source node corresponding to the data transaction, a destination ID indicative of a destination node corresponding to the data transaction, a date corresponding to the data transaction, a time corresponding to the data transaction, an access type corresponding to the data transaction, validation information corresponding to the data transaction, blockchain permission information associated with the blockchain ledger, or a blockchain ID associated with the blockchain ledger.

In some implementations, the at least one blockchain ID may include a primary blockchain ID associated with a primary blockchain ledger or a secondary blockchain ID associated with a secondary blockchain ledger. In some implementations, the at least one data field of the blockchain ledger may be masked based on a node ID associated with a network node. In some implementations, the at least one data field of the blockchain ledger may be masked based on a data set ID, a privacy level corresponding to the data set, a source ID indicative of a source node corresponding to the data transaction, a destination ID indicative of a destination node corresponding to the data transaction, validation information corresponding to the data transaction, blockchain permission information associated with the blockchain ledger, or a blockchain ID associated with the blockchain ledger, among other examples. In some implementations, the at least one data field of the blockchain ledger may be masked based on at least one of a function ID associated with a function, a service ID associated with a service, or an application ID associated with an application, among other examples. In some implementations, the at least one data field of the blockchain ledger may be masked based on a user ID associated with a user device. In some implementations, the blockchain permission scheme may include a role-based access control scheme, a user-based access control scheme, a group-based access control scheme, or an object-based access control scheme, among other examples.

In some implementations, the technique 1800 may include transmitting a transaction request message indicative of a proposed data transaction associated with the data set; receiving at least one transaction validation message based on the transaction request message; and causing an occurrence of the proposed data transaction based on the at least one transaction validation message, wherein the data transaction is detected based on causing the occurrence of the proposed data transaction. In some implementations, the technique 1800 may include determining a blockchain permission indicator value and outputting, for display and based on the blockchain permission indicator value, a representation of the at least one data field.

In some implementations, the technique 1800 may include instantiating an exposure entity that is configured to expose at least one value of the at least one data field; determining a blockchain permission indicator value; obtaining, from the exposure entity and based on the blockchain permission indicator value, the at least one value of the at least one data field; and outputting, for display, a representation of the at least one value of the at least one data field. In some implementations, the technique 1800 may include receiving a data transaction verification request; determining that the data transaction verification request corresponds to the data transaction; and verifying the data transaction based on determining that the data transaction verification request corresponds to the data transaction.

In some implementations, the technique 1800 may include determining that the data transaction is a data deletion request and deleting the data set based on determining that the data transaction is the data deletion request. In some implementations, the technique 1800 may include determining that the data transaction is a data access request and obtaining, based on determining that the data transaction is the data access request, an access control indication associated with the data set; and outputting, based on the access control indication, at least one of a representation of the data set, or a representation of at least one data field of the blockchain ledger.

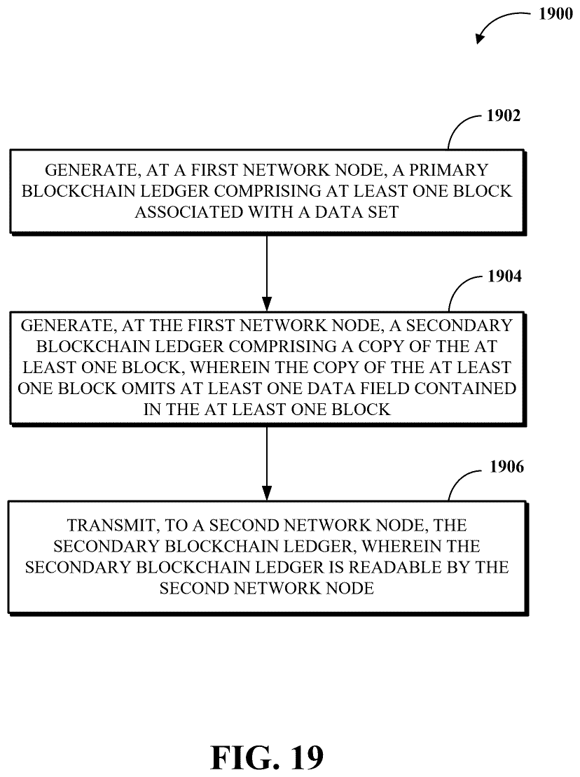

FIG. 19 is a flowchart of an example of a technique 1900 for blockchain-verified data tracking. The technique 1900 can be executed using computing devices, such as the systems, hardware, and software described with respect to FIGS. 1-17. The technique 1900 can be performed, for example, by executing a machine-readable program or other computer-executable instructions, such as routines, instructions, programs, or other code. The steps, or operations, of the technique 1900, or another technique, method, process, or algorithm described in connection with the implementations disclosed herein can be implemented directly in hardware, firmware, software executed by hardware, circuitry, or a combination thereof.

For simplicity of explanation, the technique 1900 is depicted and described herein as a series of steps or operations. However, the steps or operations of the technique 1900 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The step 1902 includes generating, at a first network node, a primary blockchain ledger comprising at least one block associated with a data set. In some implementations, the technique 1900 may include determining that the data set comprises personal data, and generating the primary blockchain ledger may include generating the primary blockchain ledger based on determining that the data set comprises personal data. The primary blockchain ledger may include at least one additional block associated with at least one additional data set. The primary blockchain ledger may include a set of data-specific data fields, a set of transaction-specific data fields, and a set of blockchain-specific data fields.

The step 1904 includes generating, at the first network node, a secondary blockchain ledger comprising a copy of the at least one block, where the copy of the at least one block omits at least one data field contained in the at least one block. The secondary blockchain ledger may include a set of data-specific data fields, a set of transaction-specific data fields, and a set of blockchain-specific data fields. The step 1906 includes transmitting, to a second network node, the secondary blockchain ledger, where the secondary blockchain ledger is readable by the second network node. In some implementations, the technique 1900 may include transmitting a copy of the secondary blockchain ledger to at least one additional network node.

In some implementations, the primary blockchain ledger may include at least one additional block associated with at least one additional data set, and the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, where the additional secondary blockchain ledger is readable by the at least one additional network node.

In some implementations, the technique 1900 may include transmitting a transaction request message indicative of a proposed data transaction associated with the data set; receiving at least one transaction validation message based on the transaction request message; and causing an occurrence of the proposed data transaction based on the at least one transaction validation message, where the data transaction is detected based on causing the occurrence of the proposed data transaction. In some implementations, the technique 1900 may include determining a blockchain permission indicator value; and outputting, for display and based on the blockchain permission indicator value, a representation of the at least one data field. In some implementations, the technique 1900 may include receiving, from the second network node, a blockchain update indication comprising at least one of a copy of the at least one block or an additional copy of the secondary blockchain ledger; and updating the primary blockchain ledger based on the blockchain update indication.

In some implementations, the technique 1900 may include transmitting a copy of the secondary blockchain ledger to at least one additional network node; receiving, from the second network node, a blockchain update indication; updating the primary blockchain ledger based on the blockchain update indication; generating an updated secondary blockchain ledger based on the blockchain update indication; and transmitting the updated secondary blockchain ledger to the at least one additional network node. In some implementations, the technique 1900 may include receiving, from the second network node, a blockchain update indication associated with a data transaction; adding a block to the primary blockchain ledger to generate an updated primary blockchain ledger based on the blockchain update indication; generating an updated secondary blockchain ledger based on the updated primary blockchain ledger; and transmitting a copy of the updated secondary blockchain ledger to the second network node.

In some implementations, the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, wherein the additional secondary blockchain ledger is readable by the at least one additional network node, where the secondary blockchain ledger and the additional secondary blockchain ledger are associated with different access control schemes. In some implementations, the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, where the additional secondary blockchain ledger is readable by the at least one additional network node, wherein the secondary blockchain ledger and the additional secondary blockchain ledger are associated with different data types

In some implementations, the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, where the additional secondary blockchain ledger is readable by the at least one additional network node, wherein the secondary blockchain ledger and the additional secondary blockchain ledger are associated with different privacy levels.

In some implementations, the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, where the additional secondary blockchain ledger is readable by the at least one additional network node, wherein the secondary blockchain ledger and the additional secondary blockchain ledger are associated with different access types.

In some implementations, the technique 1900 may include generating an additional secondary blockchain ledger comprising a copy of the at least one additional block, where the copy of the at least one additional block omits at least one data field contained in the at least one additional block; and transmitting, to at least one additional network node, the additional secondary blockchain ledger, where the additional secondary blockchain ledger is readable by the at least one additional network node, wherein the secondary blockchain ledger and the additional secondary blockchain ledger are associated with different data usage types

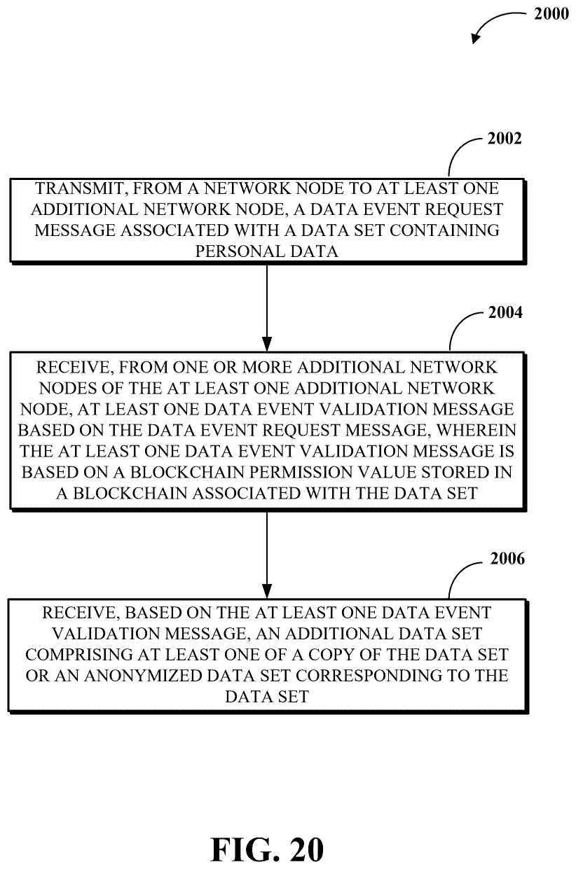

FIG. 20 is a flowchart of an example of a technique 2000 for blockchain-verified data tracking. The technique 2000 can be executed using computing devices, such as the systems, hardware, and software described with respect to FIGS. 1-17. The technique 2000 can be performed, for example, by executing a machine-readable program or other computer-executable instructions, such as routines, instructions, programs, or other code. The steps, or operations, of the technique 2000, or another technique, method, process, or algorithm described in connection with the implementations disclosed herein can be implemented directly in hardware, firmware, software executed by hardware, circuitry, or a combination thereof.

For simplicity of explanation, the technique 2000 is depicted and described herein as a series of steps or operations. However, the steps or operations of the technique 2000 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The step 2002 includes transmitting, from a network node to at least one additional network node, a data transaction request message associated with a data set containing personal data. In some implementations, the technique 2000 may include determining that the data set comprises personal data, and transmitting the data transaction request message may include transmitting the data transaction request message based on determining that the data set comprises personal data.

The step 2004 includes receiving, from one or more additional network nodes of the at least one additional network node, at least one data transaction validation message based on the data transaction request message, where the at least one data transaction validation message is based on a blockchain permission value stored in a blockchain associated with the data set. In some implementations, the blockchain permission value may be based on at least one of a role-based access control scheme, a user-based access control scheme, a group-based access control scheme, or an object-based access control scheme, among other examples.

The step 2006 includes receiving, based on the at least one data transaction validation message, an additional data set comprising at least one of a copy of the data set or an anonymized data set corresponding to the data set. In some implementations, receiving the additional data set may include receiving the additional data set from the at least one additional network node. In some implementations, the network node may include a telemetry service, and receiving the additional data set may include receiving the additional data set from a customer device. In some implementations, the network node may include a data web service, and receiving the additional data set may include receiving the additional data set from an infrastructure. In some implementations, the network node may include a compute engine, and receiving the additional data set may include receiving the additional data set from a data store.

In some implementations, the technique 2000 may include adding a block to the blockchain based on receiving the additional data set and transmitting a copy of the blockchain to at least one additional network node. In some implementations, the technique 2000 may include adding a block to the blockchain based on receiving the additional data set; transmitting a blockchain update indication to at least one additional network node; adding a block to the blockchain based on receiving the additional data set; adding a block to the blockchain based on receiving the additional data set; and transmitting a blockchain update indication to the at least one additional network node, where the blockchain update indication comprises at least one of a copy of the data set or an additional copy of the additional data set.

In some implementations, the technique 2000 may include receiving, from at least one additional network node, a blockchain update indication associated with a data transaction, where the blockchain update indication comprises at least one of a copy of the data set or an additional copy of the additional data set; and adding a block to the blockchain based on the blockchain update indication. In some implementations, the additional data set may include the anonymized data set, and the technique 2000 may further include adding a block to the blockchain based on receiving the anonymized data set, where the block comprises a data type indicator indicative of the anonymized data set. In some implementations, the additional data set comprises the anonymized data set, and the technique 2000 may further include adding a block to the blockchain based on receiving the anonymized data set, where the block comprises an access type indicator indicative of the anonymized data set. In some implementations, the additional data set comprises the copy of the data set, and the technique 2000 may further include adding a block to the blockchain based on receiving the copy of the data set, where the block comprises a data type indicator indicative of the copy of the data set.

In some implementations, the technique 2000 may include transmitting a transaction request message indicative of a proposed data transaction associated with the data set; receiving at least one transaction validation message based on the transaction request message; and causing an occurrence of the proposed data transaction based on the at least one transaction validation message, wherein the data transaction is detected based on causing the occurrence of the proposed data transaction. In some implementations, the technique 2000 may include determining a blockchain permission indicator value; and outputting, for display and based on the blockchain permission indicator value, a representation of the at least one data field.

In some implementations, the technique 2000 may include adding a block to the blockchain based on receiving the additional data set; transmitting, to the at least one additional network node, a blockchain update indication associated with adding the block; performing a data transaction associated with the additional data set; adding an additional block to the blockchain based on the data transaction; and transmitting, to the at least one additional network node, a blockchain update indication associated with adding the additional block.

Some implementations include a method, comprising: detecting a data transaction associated with a data set; storing, by a network node and based on detecting the data transaction, data transaction information in a block of a copy of a blockchain ledger, wherein at least one data field of the blockchain ledger is masked based on a blockchain permission scheme; and transmitting, to at least one additional network node and based on storing the data transaction information, a blockchain update indication comprising at least one of a copy of the block or an additional copy of the blockchain ledger.

In some implementations, the method includes determining that the data set comprises personal data, wherein storing the data transaction information comprises storing the data transaction information based on determining that the data set comprises personal data.

In some implementations, the method includes transmitting a transaction request message indicative of a proposed data transaction associated with the data set; receiving at least one transaction validation message based on the transaction request message; and causing an occurrence of the proposed data transaction based on the at least one transaction validation message, wherein the data transaction is detected based on causing the occurrence of the proposed data transaction.

In some implementations, the method includes determining a blockchain permission indicator value; and outputting, for display and based on the blockchain permission indicator value, a representation of the at least one data field.

In some implementations, the method includes instantiating an exposure entity that is configured to expose at least one value of the at least one data field; determining a blockchain permission indicator value; obtaining, from the exposure entity and based on the blockchain permission indicator value, the at least one value of the at least one data field; and outputting, for display, a representation of the at least one value of the at least one data field.

In some implementations, storing the data transaction information comprises: storing one or more values in one or more data fields of the blockchain ledger, wherein the one or more data fields include the at least one data field, and wherein the at least one data field is indicative of at least one of: a data set ID, a privacy level corresponding to the data set, a source ID indicative of a source node corresponding to the data transaction, a destination ID indicative of a destination node corresponding to the data transaction, a date corresponding to the data transaction, a time corresponding to the data transaction, an access type corresponding to the data transaction, validation information corresponding to the data transaction, blockchain permission information associated with the blockchain ledger, or a blockchain ID associated with the blockchain ledger.

In some implementations, the method includes receiving a data transaction verification request; determining that the data transaction verification request corresponds to the data transaction; and verifying the data transaction based on determining that the data transaction verification request corresponds to the data transaction.

In some implementations, the method includes determining that the data transaction is a data deletion request; and deleting the data set based on determining that the data transaction is the data deletion request.

In some implementations, the method includes determining that the data transaction is a data access request; and obtaining, based on determining that the data transaction is the data access request, an access control indication associated with the data set; and outputting, based on the access control indication, at least one of: a representation of the data set, or a representation of at least one data field of the blockchain ledger.

In some implementations, the at least one data field of the blockchain ledger is masked based on a node ID associated with a network node.

Some implementations include a non-transitory computer-readable medium storing instructions operable to cause one or more processors to perform operations comprising: detecting a data transaction associated with a data set; storing, by a network node and based on detecting the data transaction, data transaction information in a block of a copy of a blockchain ledger, wherein at least one data field of the blockchain ledger is masked based on a blockchain permission scheme; and transmitting, to at least one additional network node and based on storing the data transaction information, a blockchain update indication comprising at least one of a copy of the block or an additional copy of the blockchain ledger.

In some implementations, the blockchain ledger comprises at least one blockchain ID, the at least one blockchain ID comprising at least one of a: primary blockchain ID associated with a primary blockchain ledger, or a secondary blockchain ID associated with a secondary blockchain ledger.

In some implementations, the blockchain ledger corresponds to at least one of the data set, a service, an application, or a function associated with at least one of a service or an application.

In some implementations, the blockchain permission scheme comprises at least one of: a role-based access control scheme, a user-based access control scheme, a group-based access control scheme, or an object-based access control scheme.

In some implementations, the at least one data field of the blockchain ledger is masked based on at least one of: a data set ID, a privacy level corresponding to the data set, a source ID indicative of a source node corresponding to the data transaction, a destination ID indicative of a destination node corresponding to the data transaction, validation information corresponding to the data transaction, blockchain permission information associated with the blockchain ledger, or a blockchain ID associated with the blockchain ledger.

In some implementations, the at least one data field of the blockchain ledger is masked based on at least one of a function ID associated with a function, a service ID associated with a service, or an application ID associated with an application.

Some implementations include a system, comprising: one or more memories; and one or more processors configured to execute instructions stored in the one or more memories to cause the system to: detect a data transaction associated with a data set; store, by a network node and based on detecting the data transaction, data transaction information in a block of a copy of a blockchain ledger, wherein at least one data field of the blockchain ledger is masked based on a blockchain permission scheme; and transmit, to at least one additional network node and based on storing the data transaction information, a blockchain update indication comprising at least one of a copy of the block or an additional copy of the blockchain ledger.

In some implementations, the at least one data field of the blockchain ledger is masked based on a user ID associated with a user device.

In some implementations, the blockchain ledger comprises a set of data-specific data fields, a set of transaction-specific data fields, and a set of blockchain-specific data fields.

In some implementations, the data transaction comprises a data movement transaction, a data access transaction, a data deletion transaction, a data modification transaction, or a data usage transaction

Some implementations include a method, comprising: generating, at a first network node, a primary blockchain ledger comprising at least one block associated with a data set; generating, at the first network node, a secondary blockchain ledger comprising a copy of the at least one block, wherein the copy of the at least one block omits at least one data field contained in the at least one block; and transmitting, to a second network node, the secondary blockchain ledger, wherein the secondary blockchain ledger is readable by the second network node.

In some implementations, the primary blockchain ledger comprises at least one additional block associated with at least one additional data set, the method further comprising:
generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node.

In some implementations, the method comprises determining that the data set comprises personal data, wherein generating the primary blockchain ledger comprises generating the primary blockchain ledger based on determining that the data set comprises personal data.

In some implementations, the method comprises transmitting a transaction request message indicative of a proposed data transaction associated with the data set; receiving at least one transaction validation message based on the transaction request message; and causing an occurrence of the proposed data transaction based on the at least one transaction validation message, wherein the data transaction is detected based on causing the occurrence of the proposed data transaction.

In some implementations, the method comprises determining a blockchain permission indicator value; and outputting, for display and based on the blockchain permission indicator value, a representation of the at least one data field.

In some implementations, the method comprises receiving, from the second network node, a blockchain update indication comprising at least one of a copy of the at least one block or an additional copy of the secondary blockchain ledger; and updating the primary blockchain ledger based on the blockchain update indication.

In some implementations, the method comprises transmitting a copy of the secondary blockchain ledger to at least one additional network node.

In some implementations, the method comprises transmitting a copy of the secondary blockchain ledger to at least one additional network node; receiving, from the second network node, a blockchain update indication; updating the primary blockchain ledger based on the blockchain update indication; generating an updated secondary blockchain ledger based on the blockchain update indication; and transmitting the updated secondary blockchain ledger to the at least one additional network node.

In some implementations, the method comprises receiving, from the second network node, a blockchain update indication associated with a data transaction; adding a block to the primary blockchain ledger to generate an updated primary blockchain ledger based on the blockchain update indication; generating an updated secondary blockchain ledger based on the updated primary blockchain ledger; and transmitting a copy of the updated secondary blockchain ledger to the second network node.

In some implementations, the primary blockchain ledger comprises at least one additional block associated with at least one additional data set.

Some implementations include a non-transitory computer-readable medium storing instructions operable to cause one or more processors to perform operations comprising: generating, at a first network node, a primary blockchain ledger comprising at least one block associated with a data set; generating, at the first network node, a secondary blockchain ledger comprising a copy of the at least one block, wherein the copy of the at least one block omits at least one data field contained in the at least one block; and transmitting, to a second network node, the secondary blockchain ledger, wherein the secondary blockchain ledger is readable by the second network node.

The non-transitory computer-readable medium of claim 11, further comprising: receiving, from the second network node, a blockchain update indication associated with a data transaction, wherein the blockchain update indication comprises at least one of a copy of the at least one block or an additional copy of the secondary blockchain ledger; and adding a block to the primary blockchain ledger based on the blockchain update indication.

In some implementations, the primary blockchain ledger comprises at least one additional block associated with at least one additional data set, the method further comprising: generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node, wherein the secondary blockchain ledger and the additional secondary blockchain ledger are associated with different access control schemes.

In some implementations, the primary blockchain ledger comprises at least one additional block associated with at least one additional data set, the method further comprising: generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node, wherein the secondary blockchain ledger and the additional secondary blockchain ledger are associated with different data types.

In some implementations, the primary blockchain ledger comprises at least one additional block associated with at least one additional data set, the method further comprising: generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node, wherein the secondary blockchain ledger and the additional secondary blockchain ledger are associated with different privacy levels.

In some implementations, the primary blockchain ledger comprises at least one additional block associated with at least one additional data set, the method further comprising: generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node, wherein the secondary blockchain ledger and the additional secondary blockchain ledger are associated with different access types.

In some implementations, the primary blockchain ledger comprises at least one additional block associated with at least one additional data set, the method further comprising: generating an additional secondary blockchain ledger comprising a copy of the at least one additional block, wherein the copy of the at least one additional block omits at least one data field contained in the at least one additional block; and transmitting, to at least one additional network node, the additional secondary blockchain ledger, wherein the additional secondary blockchain ledger is readable by the at least one additional network node, wherein the secondary blockchain ledger and the additional secondary blockchain ledger are associated with different data usage types.

Some implementations include a system, comprising: one or more memories; and one or more processors configured to execute instructions stored in the one or more memories to cause the system to: generate, at a first network node, a primary blockchain ledger comprising at least one block associated with a data set; generate, at the first network node, a secondary blockchain ledger comprising a copy of the at least one block, wherein the copy of the at least one block omits at least one data field contained in the at least one block; and transmit, to a second network node, the secondary blockchain ledger, wherein the secondary blockchain ledger is readable by the second network node.

In some implementations, the primary blockchain ledger comprises at least one additional block associated with at least one additional data set, and wherein the one or more processors are further configured to execute the instructions to cause the system to: generate an additional secondary blockchain ledger comprising a copy of the at least one additional block, wherein the copy of the at least one additional block omits at least one data field contained in the at least one additional block; and transmit, to at least one additional network node, the additional secondary blockchain ledger, wherein the additional secondary blockchain ledger is readable by the at least one additional network node, wherein the secondary blockchain ledger and the additional secondary blockchain ledger are associated with different data sources.

In some implementations, the primary blockchain ledger comprises a set of data-specific data fields, a set of transaction-specific data fields, and a set of blockchain-specific data fields.

Some implementations include a method comprising: transmitting, from a network node to at least one additional network node, a data transaction request message associated with a data set containing personal data; receiving, from one or more additional network nodes of the at least one additional network node, at least one data transaction validation message based on the data transaction request message, wherein the at least one data transaction validation message is based on a blockchain permission value stored in a blockchain associated with the data set; and receiving, based on the at least one data transaction validation message, an additional data set comprising at least one of a copy of the data set or an anonymized data set corresponding to the data set.

In some implementations, the blockchain permission value is based on at least one of a role-based access control scheme, a user-based access control scheme, a group-based access control scheme, or an object-based access control scheme.

In some implementations, the method comprises determining that the data set comprises personal data, wherein transmitting the data transaction request message comprises transmitting the data transaction request message based on determining that the data set comprises personal data.

In some implementations, the method comprises transmitting a transaction request message indicative of a proposed data transaction associated with the data set; receiving at least one transaction validation message based on the transaction request message; and causing an occurrence of the proposed data transaction based on the at least one transaction validation message, wherein the data transaction is detected based on causing the occurrence of the proposed data transaction.

In some implementations, the method comprises determining a blockchain permission indicator value; and outputting, for display and based on the blockchain permission indicator value, a representation of the at least one data field.

In some implementations, the method comprises adding a block to the blockchain based on receiving the additional data set.

In some implementations, the additional data set comprises the anonymized data set, the method further comprising: adding a block to the blockchain based on receiving the anonymized data set, wherein the block comprises a data type indicator indicative of the anonymized data set.

In some implementations, the additional data set comprises the anonymized data set, the method further comprising: adding a block to the blockchain based on receiving the anonymized data set, wherein the block comprises an access type indicator indicative of the anonymized data set.

In some implementations, the additional data set comprises the copy of the data set, the method further comprising: adding a block to the blockchain based on receiving the copy of the data set, wherein the block comprises a data type indicator indicative of the copy of the data set.

In some implementations, the method comprises adding a block to the blockchain based on receiving the additional data set; and transmitting a copy of the blockchain to at least one additional network node.

Some implementations include a non-transitory computer-readable medium storing instructions operable to cause one or more processors to perform operations comprising: transmitting, from a network node to at least one additional network node, a data transaction request message associated with a data set containing personal data; receiving, from one or more additional network nodes of the at least one additional network node, at least one data transaction validation message based on the data transaction request message, wherein the at least one data transaction validation message is based on a blockchain permission value stored in a blockchain associated with the data set; and receiving, based on the at least one data transaction validation message, an additional data set comprising at least one of a copy of the data set or an anonymized data set corresponding to the data set.

The non-transitory computer-readable medium of claim 11, further comprising: adding a block to the blockchain based on receiving the additional data set; transmitting a blockchain update indication to at least one additional network node.

The non-transitory computer-readable medium of claim 11, further comprising: adding a block to the blockchain based on receiving the additional data set; and transmitting a blockchain update indication to the at least one additional network node, wherein the blockchain update indication comprises at least one of a copy of the data set or an additional copy of the additional data set.

The non-transitory computer-readable medium of claim 11, further comprising: receiving, from at least one additional network node, a blockchain update indication associated with a data transaction, wherein the blockchain update indication comprises at least one of a copy of the data set or an additional copy of the additional data set; and adding a block to the blockchain based on the blockchain update indication.

The non-transitory computer-readable medium of claim 11, further comprising: adding a block to the blockchain based on receiving the additional data set; transmitting, to the at least one additional network node, a blockchain update indication associated with adding the block; performing a data transaction associated with the additional data set; adding an additional block to the blockchain based on the data transaction; and transmitting, to the at least one additional network node, a blockchain update indication associated with adding the additional block.

In some implementations, receiving the additional data set comprises receiving the additional data set from the at least one additional network node.

Some implementations include a Some implementations include a system, comprising: one or more memories; and one or more processors configured to execute instructions stored in the one or more memories to cause the system to: transmit, from a network node to at least one additional network node, a data transaction request message associated with a data set containing personal data; receive, from one or more additional network nodes of the at least one additional network node, at least one data transaction validation message based on the data transaction request message, wherein the at least one data transaction validation message is based on a blockchain permission value stored in a blockchain associated with the data set; and receive, based on the at least one data transaction validation message, an additional data set comprising at least one of a copy of the data set or an anonymized data set corresponding to the data set.

In some implementations, the network node comprises a telemetry service, and wherein, to receive the additional data set, the one or more processors are configured to cause the system to: receive the additional data set from a customer device.

In some implementations, the network node comprises a data web service, and wherein, to receive the additional data set, the one or more processors are configured to cause the system to: receive the additional data set from an infrastructure.

In some implementations, the network node comprises a compute engine, and wherein, to receive the additional data set, the one or more processors are configured to cause the system to: receive the additional data set from a data store.

As used herein, unless explicitly stated otherwise, any term specified in the singular may include its plural version. For example, “a computer that stores data and runs software,” may include a single computer that stores data and runs software or two computers - a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
transmitting, from a network node to at least one additional network node, a data transaction request message associated with a data set containing personal data;
receiving, from one or more additional network nodes of the at least one additional network node, at least one data transaction validation message based on the data transaction request message, wherein the at least one data transaction validation message is based on a blockchain permission value stored in a blockchain associated with the data set; and
receiving, based on the at least one data transaction validation message, an additional data set comprising at least one of a copy of the data set or an anonymized data set corresponding to the data set.

2. The method of claim 1, wherein the blockchain permission value is based on at least one of a role-based access control scheme, a user-based access control scheme, a group-based access control scheme, or an object-based access control scheme.

3. The method of claim 1, further comprising:
determining that the data set comprises personal data, wherein transmitting the data transaction request message comprises transmitting the data transaction request message based on determining that the data set comprises personal data.

4. The method of claim 1, further comprising:
transmitting a transaction request message indicative of a proposed data transaction associated with the data set;
receiving at least one transaction validation message based on the transaction request message; and
causing an occurrence of the proposed data transaction based on the at least one transaction validation message, wherein the data transaction is detected based on causing the occurrence of the proposed data transaction.

5. The method of claim 1, further comprising:
providing the additional data set as input to a machine learning model; and
adding a block to the blockchain based on providing the additional data set as input to the machine learning model.

6. The method of claim 1, further comprising:
adding a block to the blockchain based on receiving the additional data set.

7. The method of claim 1, wherein the additional data set comprises the anonymized data set, the method further comprising:
adding a block to the blockchain based on receiving the anonymized data set, wherein the block comprises a data type indicator indicative of the anonymized data set.

8. The method of claim 1, wherein the additional data set comprises the anonymized data set, the method further comprising:
adding a block to the blockchain based on receiving the anonymized data set, wherein the block comprises an access type indicator indicative of the anonymized data set.

9. The method of claim 1, wherein the additional data set comprises the copy of the data set, the method further comprising:
adding a block to the blockchain based on receiving the copy of the data set, wherein the block comprises a data type indicator indicative of the copy of the data set.

10. The method of claim 1, further comprising:
adding a block to the blockchain based on receiving the additional data set; and
transmitting a copy of the blockchain to at least one additional network node.

11. A non-transitory computer-readable medium storing instructions operable to cause one or more processors to perform operations comprising:
transmitting, from a network node to at least one additional network node, a data transaction request message associated with a data set containing personal data;
receiving, from one or more additional network nodes of the at least one additional network node, at least one data transaction validation message based on the data transaction request message, wherein the at least one data transaction validation message is based on a blockchain permission value stored in a blockchain associated with the data set; and
receiving, based on the at least one data transaction validation message, an additional data set comprising at least one of a copy of the data set or an anonymized data set corresponding to the data set.

12. The non-transitory computer-readable medium of claim 11, further comprising:
adding a block to the blockchain based on receiving the additional data set;
transmitting a blockchain update indication to at least one additional network node.

13. The non-transitory computer-readable medium of claim 11, further comprising:
adding a block to the blockchain based on receiving the additional data set; and
transmitting a blockchain update indication to the at least one additional network node, wherein the blockchain update indication comprises at least one of a copy of the data set or an additional copy of the additional data set.

14. The non-transitory computer-readable medium of claim 11, further comprising:
receiving, from at least one additional network node, a blockchain update indication associated with a data transaction, wherein the blockchain update indication comprises at least one of a copy of the data set or an additional copy of the additional data set; and
adding a block to the blockchain based on the blockchain update indication.

15. The non-transitory computer-readable medium of claim 11, further comprising:
adding a block to the blockchain based on receiving the additional data set;
transmitting, to the at least one additional network node, a blockchain update indication associated with adding the block;
performing a data transaction associated with the additional data set;
adding an additional block to the blockchain based on the data transaction; and
transmitting, to the at least one additional network node, a blockchain update indication associated with adding the additional block.

16. The non-transitory computer-readable medium of claim 11, wherein receiving the additional data set comprises receiving the additional data set from the at least one additional network node.

17. A system, comprising:
one or more memories; and
one or more processors configured to execute instructions stored in the one or more memories to cause the system to:
transmit, from a network node to at least one additional network node, a data transaction request message associated with a data set containing personal data;
receive, from one or more additional network nodes of the at least one additional network node, at least one data transaction validation message based on the data transaction request message, wherein the at least one data transaction validation message is based on a blockchain permission value stored in a blockchain associated with the data set; and
receive, based on the at least one data transaction validation message, an additional data set comprising at least one of a copy of the data set or an anonymized data set corresponding to the data set.

18. The system of claim 17, wherein the network node comprises a telemetry service, and wherein, to receive the additional data set, the one or more processors are configured to cause the system to:
receive the additional data set from a customer device.

19. The system of claim 17, wherein the network node comprises a data web service, and wherein, to receive the additional data set, the one or more processors are configured to cause the system to:
receive the additional data set from an infrastructure.

20. The system of claim 17, wherein the network node comprises a compute engine, and wherein, to receive the additional data set, the one or more processors are configured to cause the system to:
receive the additional data set from a data store.
